(19) United States
(12) Patent Application Publication
(10) Pub. No.: US 2001/0019536 A1
(43) Pub. Date: Sep. 6, 2001

(54) Line restoring method and packet transmission equipment

(76) Inventor: Hiroyuki Suzuki, Kawasaki (JP)

Correspondence Address: HELFGOTT & KARAS, P.C., EMPIRE STATE BUILDING, 60TH FLOOR, NEW YORK, NY, 10118, US

(21) Appl. No.: 09/800,151

(22) Filed: Mar. 5, 2001

(30) Foreign Application Priority Data
Mar. 6, 2000 (JP) 2000-061203
Jan. 16, 2001 (JP) 2001-007757

(51) Int. Cl. H04J 3/14; H04L 12/26; H04J 1/16

(52) U.S. Cl. 370/226; 370/228

(57) ABSTRACT

The invention relates to a line restoring method for securing, efficiently at a low cost, a substitute path for every path that is logically formed in a transmission section where a failure has occurred in a node of a packet routing network formed by physical transmission paths that are installed over a wide area or a long distance and formed redundantly, as well as to a packet transmission equipment that realizes such a line restoring method. In a network to which the invention is applied, it is possible to flexibly adapt to a variety of configurations of a network and transmission paths and increase the operation efficiency and the total reliability.

### BACKGROUND OF THE INVENTION

1. Field of the Invention

The present invention relates to a line restoring method in a packet routing network in which transmission paths are formed redundantly. The line restoring method determines, according to a routing control procedure of the packet routing network, a transmission path for replacement of a transmission section where a failure has occurred. The invention also relates to a packet transmission equipment to be provided at a node where the line restoring method is realized.

2. Description of the Related Art

In recent years, a variety of data communication services have been provided via the Internet and mobile communication networks. The number of terminals given such data communication services is rapidly increasing. As a result, the packet transmission technology, which have been conventionally applied to specific fields such as finance, is now being positively applied to wide area networks.

FIG. 15 shows part of a packet routing network as a wide area network. As shown in FIG. 15, routers 81-11 to 81-16, 81-21 to 81-23, 81-31 and 81-32, 81-41 and 81-42, and 82-1 to 82-3 are provided as nodes together with a packet exchange 80.

For example, a synchronous optical network (SONET; not shown) that is likewise ring-shaped is formed as a lower layer of the wide area network shown in FIG. 15.

In the above synchronous optical network, a failure may occur in, for example, a transmission section between an ADM equipment (not shown) that accommodates the router 81-12 and an ADM equipment (not shown) that accommodates the router 81-13 as indicated by mark “x” in FIG. 15. In this case, the ADM equipments can detect the failure in the above transmission section as an event that an optical signal to be constantly received cannot be received.

However, a router (e.g., the router 81-12 or 81-13) that uses the upper layer of each of the above ADM equipments cannot quickly detect the failure that has occurred in the transmission path including the self equipment unlike the above ADM equipments in the synchronous optical network.

In the following, the above wide area network will be referred to simply as “first conventional example.”

At the time of a start, the routers 81-11 to 81-16, 81-21 to 81-23, 81-31 and 81-32, 81-41 and 81-42, and 82-1 to 82-3 exchange routing information to be used in the above-mentioned routing control and generate routing maps by accumulating pieces of routing information individually as databases of a predetermined format.

In a routing control process for each packet that is supplied via the preceding transmission section, each of the routers 81-11 to 81-16, 81-21 to 81-23, 81-31 and 81-32, 81-41 and 81-42, and 82-1 to 82-3 identifies a succeeding transmission section or a terminal that is accommodated by the local station based on the destination of the packet by referring to the routing map when necessary.

The above-mentioned routing maps reflect, for any transmission section, none of a transmission capacity, its excess amount (e.g., the degree of congestion), and properness of an operation state. The routers 81-11 to 81-16, 81-21 to 81-23, 81-31 and 81-32, 81-41 and 81-42, and 82-1 to 82-3 simply select, as a succeeding transmission section as mentioned above, a transmission section that is connected to an outgoing line having a smaller number of hops during the course of a routing control.

As shown in FIG. 16, in a network (hereinafter referred to as “second conventional example”) having ring-like transmission paths 91-1 and 91-2 to which the time division multiplexing transmission scheme is applied, a failure may occur in any transmission section of the one transmission path 91 -1 as indicated by mark “x” in FIG. 16, for example.

When such a failure has occurred, the node 92-1 located upstream of the transmission section (hereinafter referred to as “particular transmission section”) where the failure has occurred of the transmission path 91-1 and that is closest to the particular transmission section extracts transmission information of channels (time slots) that are multiplexed in each frame received via the transmission path 91-1 according to a prescribed frame structure and sequentially inserts the pieces of transmission information of those channels into excess time slots of each frame that is received via the preceding transmission section of the other transmission path 91-2.

Therefore, the node 92-1 forms a substitute path physically between itself and the other node that is located downstream of the transmission path 91-1 via the particular transmission section by using excess time slots (channels) of the transmission path 91-2 that is different from the transmission path 91-1.

It is noted that the above second conventional example employs the standby redundancy scheme in which an excess transmission band (time slots) of one of the transmission paths 91-1 and 91-2 is secured in such a state as to be able to replace a transmission band in current use of the other.

Therefore, in the above-described first conventional example, to select, in an IP layer, a transmission section to replace a certain transmission section where a failure has occurred, the routers 81-11 to 81-1 6, 81-21 to 81-23, 81-31 and 81-32, 81-41 and 81-42, and 82-1 to 82-3 need to update the routing maps at the same time. To this end, routing information needs to be passed mutually between the routers 81-11 to 81-16, 81-21 to 81-23, 81-31 and 81-32, 81-41 and 81-42, and 82-1 to 82-3 on a regular basis.

That is, whereas each of the routers 81-11 to 81-16, 81-21 to 81-23, 81-31 and 81-32, 81-41 and 81-42, and 82-1 to 81-3 performs a routing control in the network layer, it detects a failure that has occurred in a preceding transmission section and selects a substitute transmission section to replace the detected transmission section in the physical layer. Therefore, the speed of response to a failure is not sufficiently high. Development of a technique enabling a high-speed response to a failure is strongly desired.

However, in a packet routing network that is installed over a wide area or a long distance and in which physical transmission paths are formed redundantly, influences (e.g., where the physical transmission rate of a transmission section where a failure has occurred is 2.45 gigabits/s, communications on about 40,000 lines are interrupted if each line is a telephone line of 64 kilobits/s) of occurrence of a failure increase as the number of subscribers or the required transmission capacity increases. As the total length of the transmission paths increases, the probability that a failure such as a disconnection occurs in the transmission paths during the course of work relating to an accident or maintenance/operation becomes high.

In addition, in a network in which routing or label switching is performed according to the IP, in general it is possible to detect a failure and set a substitute route according to a higher-rank communication protocol for realizing exchange of routing information (or routing tables) as mentioned above (e.g., end to end).

However, in general, if such a communication protocol is employed, a longer time is needed to detect a failure and complete changing to a substitute route. This leads to a possibility that many flows stray while taking bypasses repeatedly in a network formed by routers and even disappear.

In an equipment (a network layer or transport layer) that is accommodated via a router, although users may be satisfied with current service quality, they may require a higher quality service.

Therefore, to attain such a high-quality service, a service provider is required to provide a packet transmission service in which only a short time is needed to replace a current route with a substitute route when a failure occurs in a synchronous optical network of the above kind and the probability that a packet disappears during its course is low.

### SUMMARY OF THE INVENTION

An object of the present invention is to provide a line storing method and a packet transmission equipment for securing, efficiently at a low cost, a substitute path for a path logically formed in a transmission section where a failure has occurred.

There has been redundant networks in which only a small part of the transmission band resource of the entire network is allocated to a reserve band of a current transmission service and part of communications to be provided as the current transmission service are secured by the allocation of the reserve band when the current transmission service is not provided as in the case of occurrence of a failure or the like. For example, such redundant networks are small-scale private networks in which a low cost takes main priority. The invention is intended to provide a novel network system clearly different from such conventional redundant networks in which the band of a transmission service is partially secured in that the network system in the invention has a high degree of availability.

Another object of the invention is to effectively utilize the transmission band of each transmission section for a general transmission service without reserving the transmission band to form a substitute path for preparing for the occurrence of an unpredictable failure as in a best effort service as long as allowable loss or discard of a packet in a transmission path is recognized as an attribute of the packet.

Another object of the invention is to maintain high service quality as long as a combination of channel configuration, a transmission rate, a traffic distribution of individual transmission sections, and transmission sections where failures have occurred in parallel is properly determined in advance even when a failure has occurred in a succeeding transmission section of a transmission path.

Another object of the invention is to reliably form a reserve path by reserving part of a transmission band even in a state no failure has occurred and to use it for a relay of a packet with promptness and high reliability in place of an active path having a succeeding transmission section where a failure has occurred.

Another object of the invention is to effectively utilize a transmission band other than ones assigned to reserve paths for a transmission service without substantial deterioration in transmission efficiency and transmission quality as long as the ratio of bandwidth of the transmission band to the sum of bandwidths of transmission bands of all transmission paths is appropriate to an actually possible traffic distribution.

Another object of the invention is to acquire or secure a transmission path or a path capable of substituting a transmission section where a failure has occurred, in a service form suitable for a best effort, a control-loaded, or a guaranteed type to be applied to transmission of a packet to be relayed.

Still another object of the invention is to apply a line restoring method and a packet transmission equipment to a communication system to be provided with various forms of communication service.

Yet another object of the invention is to apply a line restoring method and a packet transmission equipment to a transmission system in which packet transmission is performed as a connectionless service or a connection-oriented communication service via duplex, circular transmission paths.

A further object of the invention is to effectively utilize a transmission path where a 6 failure has occurred for forming a path to other node in a desired layer superior to a physical layer.

Another object of the invention is to effectively utilize each node connected with a packet transmission equipment via a succeeding transmission section of a transmission path for forming a normal path in a desired layer superior to a physical layer.

Another object of the invention is to effectively utilize normal transmission sections of a transmission path where a failure has occurred, in a form suitable for a communication service, maintenance, and operation, compared with a case where other transmission path capable of substituting the transmission path is selected in a physical layer.

Another object of the invention is to increase transmission efficiency and utilize resources with efficiency.

Another object of the invention is to transmit a packet to a succeeding transmission section with guaranteed formation of a normal path between a packet transmission equipment and a desired destination of the packet in a transport label layer irrespective of a number and a combination of transmission sections which have not recovered yet from failures that have occurred in parallel.

Another object of the invention is to suppress traffic increase in a substitute path, improve service quality, and reduce running cost.

Yet another object of the invention is to allow a sender of a packet previously transmitted to a destination but not yet completed owing to a failure in one transmission section of a transmission path, to reliably identify the packet to be retransmitted to a substitute path.

Yet another object of the invention is to allow other nodes to utilize ones, of the transmission sections of a transmission path, different from either or both of a preceding transmission section and a succeeding transmission section directly connected with an interfacing section where a failure has occurred, in a desired layer superior to a physical layer.

A further object of the invention is to allow each node connected with a packet transmission equipment via a normal succeeding transmission section other than preceding and succeeding transmission sections directly connected with an interfacing section where a failure has occurred, to effectively utilize normal transmission sections by identifying a transmission section where the failure has occurred, in a desired layer superior to a physical layer.

Another object of the invention is to effectively utilize normal transmission sections of a transmission path where a failure has occurred, in a manner suitable for a communication service, maintenance, and operation, compared with a case where other transmission path capable of substituting the transmission path is selected in a physical layer.

Another object of the invention is to make it possible to receive a packet supplied via even a preceding transmission section directly connected with an interfacing section where a failure has occurred, when the failure has a specific form.

Another object of the invention is to make it possible to transmit a packet to even a succeeding transmission section directly connected with an interfacing section where a failure has occurred, when the failure has a specific form.

Another object of the invention is to transmit a packet to a normal path formed between a packet transmission equipment and a desired destination of the packet in a transport label layer irrespective of a number and a combination of transmission sections which have not recovered yet from failures which have occurred in parallel with a plurality of interfacing sections.

Another object of the invention is to suppress increase in the traffic of a substitute path formed due to a failure in one interfacing section and to reduce running cost and improve service quality.

Another object of the invention is to recover from a failure in a transmission path or an interfacing section by routing either or both of a previously transmitted packet and a packet to be subsequently transmitted.

Still another object of the invention is to allow a node as a sender of each packet to retransmit the packet to a desired incoming/outgoing line when a failure has occurred as long as the node can recognize a combination added to an alarm packet.

Yet another object of the invention is to apply a line restoring method and a packet transmission equipment to a data transmission system in which a guaranteed transmission service is to be provided.

A further object of the invention is to allow a data transmission system where the invention is applied, to flexibly adapt to various configurations of a network and transmission paths and to increase its operation efficiency and total reliability.

The above objects are realized by a line restoring method in which a connectionless transmission path to substitute a transmission section is secured in a logical layer when a failure has occurred in a succeeding transmission section to which a packet to be a subject of a best effort service is to be relayed.

In the above line restoring method, it is possible to utilize the transmission bands of each transmission section for a general transmission service without being reserved to form a substitute path for an unpredictable failure as long as allowable loss or discard of a packet in a transmission path is recognized as an attribute of the packet as in the case of the best effort service.

The above objects are achieved by a line restoring method in which a path to substitute a succeeding transmission section is secured in a logical layer when a failure has occurred in the transmission section to which a packet to become a subject of a control-loaded service or a guaranteed service is to be relayed.

In this line restoring method, reserve paths are reliably formed by reserving parts of transmission bands even in a state that no failure has occurred, and are used with promptness and high reliability for a relay of a packet in place of an active path having a succeeding transmission section where a failure has occurred.

The invention provides a line restoring method in which a transmission path or a path suitable for a packet to become a subject of a best effort service or for a packet to become a control-loaded or a guaranteed service, is secured.

In the above line restoring method, it is able to acquire or secure a transmission path or a path capable of substituting a transmission section where a failure has occurred, in a flexible form adapted to the form of service such as a best effort, a control-loaded, and a guaranteed, where transmission of a packet is to be relayed.

The invention provides a line restoring method in which transmission paths are duplexed, circularly formed and have opposite transmission directions and a transmission path to substitute a succeeding transmission section where a failure has occurred is secured according to loopback.

In the above line restoring method, the invention is applicable to a transmission system in which packet transmission is performed as a connectionless service via duplex, circular transmission paths.

The invention provides a line restoring method in which transmission paths are duplexed, circularly formed, and have opposite transmission directions and a transmission path to substitute a succeeding transmission section where a failure has occurred is secured by explicit rooting.

In the above line restoring method, the invention is applicable to a transmission system in which packet transmission is performed as a connection-oriented communication service via duplex circular transmission paths.

According to one aspect of the invention, there is provided a packet transmission equipment which monitors occurrence of a physical failure in transmission sections of a plurality of redundantly configured transmission paths directly connected with the equipment and transmits, when a failure has been detected, an alarm packet indicating the failure to all or part of the succeeding transmission sections of the transmission paths.

In the above packet transmission equipment, it is possible to physically detect a failure in any preceding transmission section of the transmission paths and notifies it as a message to other nodes via a transport label layer.

The invention provides a packet transmission equipment which is different from the above packet transmission equipment in adding to the alarm packet an identifier of a transmission path where a failure has been detected.

In the above packet transmission equipment, each node connected with the packet transmission equipment via the succeeding transmission section of a transmission path is notified of a transmission path where a failure has occurred.

The invention provides a packet transmission equipment which transmits, when receiving an alarm packet from the preceding transmission section of a transmission path, each packet to be subsequently transmitted to a succeeding transmission section where a substitute link has been formed and suitable for: either or both of an identifier included in the alarm packet and indicating a transmission path where a failure has occurred; and a sender and a destination of the packet.

In the above packet transmission equipment, a transmission section capable of substituting one, of the transmission sections of the transmission paths where a failure has occurred, is promptly determined according to explicit routing in a transport label layer and is used for transmitting a subsequent packet.

The invention provides a packet transmission equipment which transmits with priority a packet to a succeeding transmission section where a substitute link with a small number of times crossing-over of different transmission paths performed has been formed.

In the above packet transmission equipment, the number of times crossing-over of physically different transmission paths performed can be fewer in one, of paths formed in the transmission paths, including a transmission section to substitute a transmission section where a failure has occurred.

The invention provides a packet transmission equipment which transmits a packet to a succeeding transmission section not included in any of defective transmission sections.

In the above packet transmission equipment, a packet is transmitted to a succeeding transmission section with guaranteed formation of a normal path between the equipment and a desired destination of the packet in a transport label layer irrespective of a number and a combination of transmission sections which have not recovered yet from failures which have occurred in parallel.

The invention provides a packet transmission equipment where normal transmission sections of transmission paths including a defective transmission section is positively used for packet transmission.

In the above packet transmission equipment, in any path formed in the transmission paths, succeeding normal transmission sections of a transmission section where a failure has occurred are used for packet transmission together with a path substituting the transmission section in a transport label layer.

The invention provides a packet transmission equipment which comprises a buffer for accumulating a packet to be relayed and discards, when a failure has occurred in a preceding transmission section used for receiving the packet, a packet to be transmitted to the succeeding transmission section of the above one, and adds a sender and a sequence number included in the discarded packets to an alarm packet.

In the above packet transmission equipment, when a failure has occurred in a transmission section to which a packet is to be transmitted, the packet is discarded and notification as a combination of the above sender and the number is made of a packet to be retransmitted from the sender of the packet.

The invention provides a packet transmission equipment which monitors occurrence of a failure in a section for interfacing transmission paths and transmits, when detecting a failure, an alarm packet indicating a section having the failure to all or part of succeeding transmission sections of the transmission paths.

In the above packet transmission equipment, it is possible to physically detect a failure that has occurred in any of interfacing sections and notify other nodes of the failure as a message via a transport label layer.

The invention provides a packet transmission equipment which adds an identifier of a section where a failure has been detected to an alarm packet.

In the above packet transmission equipment, either or both of a preceding transmission section and a succeeding transmission section directly connected with an interfacing section where a failure has occurred is/are notified to each node connected with the packet transmission equipment via a normal succeeding transmission section other than the transmission section(s).

The invention provides a packet transmission equipment which transmits, when receiving an alarm packet from a preceding transmission section of a transmission path, each packet to be subsequently transmitted to a succeeding transmission section where a substitute link has been formed and suitable for: either or both of an identifier included in the alarm packet and indicating a section where a failure has occurred and a form of the failure; and a sender and a destination of the packet.

In the above packet transmission equipment, a transmission section capable of substituting a transmission section where a failure has occurred is promptly identified according to explicit routing in a transport label layer and is used for transmitting subsequent packets.

The invention provides a packet transmission equipment which transmits the above packet indicating a failure to a transmission section where a substitute link has been formed independent of possibility of receiving a packet from a preceding transmission section.

In the above packet transmission equipment, even when a preceding transmission section is directly connected with an interfacing section even where a failure has occurred, it is able to receive a packet transmitted via the transmission section.

The invention provides a packet transmission equipment which transmits the above packet indicating a failure to a transmission section where a substitute link has been formed independent of possibility of transmitting a packet to a succeeding transmission section.

In the above packet transmission equipment, a packet can be transmitted to even a succeeding transmission section directly connected with an interfacing section where a failure has occurred.

The invention provides a packet transmission equipment which transmits with priority a packet to a succeeding transmission section forming a substitute link having a small number of times crossing-over of different transmission paths performed.

In the above packet transmission equipment, the number of times crossing-over of physically different transmission paths performed can be fewer in one, of paths formed in the transmission sections of the transmission paths, including a transmission section to substitute a transmission section where a failure has occurred.

The invention provides a packet transmission equipment which transmits a packet to a succeeding transmission section connected with a section that is not any of defective sections.

In the above packet transmission equipment, a packet is transmitted to a succeeding transmission section with a guaranteed formation of a normal path to a destination of the packet in a transport label layer irrespective of a number and a combination of transmission sections which have not recovered yet from failures which have occurred in parallel.

The invention provides a packet transmission equipment which positively uses normal transmission sections of transmission paths including an defective transmission section for packet transmission.

In the above packet transmission equipment, even when a transmission section is directly connected with an interfacing section where a failure has occurred, a succeeding transmission section of the transmission path can be effectively used for packet transmission as long as it is normal.

The invention further provides a packet transmission equipment which relays an alarm packet received from a preceding transmission section to a succeeding transmission section.

In the above packet transmission equipment, an alarm packet is transferred to ones, among nodes connected with the transmission paths, other than a sender of the alarm packet.

The invention provides a packet transmission equipment which discards one, of packets to be relayed, to a succeeding transmission section via a section where a failure has occurred and adds a sender and a sequence number included in the discarded packet to an alarm packet.

In the above packet transmission equipment, each packet whose transfer to the destination has not completed yet is discarded when a failure has occurred in an interfacing section connected with transmission paths and a sender of the packet is notified of the discard.

The invention provides a packet transmission equipment which accumulates a packet previously transmitted and retransmits, when receiving an alarm packet, a packet including a sender and a sequence number same as those included in the alarm packet.

In the above packet transmission equipment, it is possible to reliably retransmit the above alarm packet, of packets transmitted to one of succeeding transmission sections of transmission paths, which is supplied from other node via the transmission paths, to an incoming/outgoing line determined by routing.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a first principle block diagram of a packet transmission equipment according to the invention;

FIG. 2 is a second principle block diagram of a packet transmission equipment according to the invention;

FIG. 3 is a third principle block diagram of a packet transmission equipment according to the invention;

FIG. 4 is a fourth principle block diagram of a packet transmission equipment according to the invention;

FIG. 5 shows the configuration of embodiments of the invention;

FIG. 6 shows a detailed configuration of a packet transmission equipment;

FIGS. 7A and 7B illustrate an operation of a first embodiment of the invention;

FIG. 8 is a flowchart showing the operation of a controlling part according to the first embodiment of the invention;

FIG. 9 shows the structure of a packet;

FIG. 10 shows the structure of a look-up table used in the first and second embodiments of the invention;

FIG. 11 shows a protocol stack according to the first embodiment of the invention;

FIGS. 12A and 12B illustrate operations of second and fourth embodiments of the invention;

FIG. 13 illustrates an operation of a fifth embodiment of the invention;

FIG. 14A and 14B illustrate operations of sixth and seventh embodiments of the invention;

FIG. 15 shows the configuration of part of a packet routing network as a wide area network; and

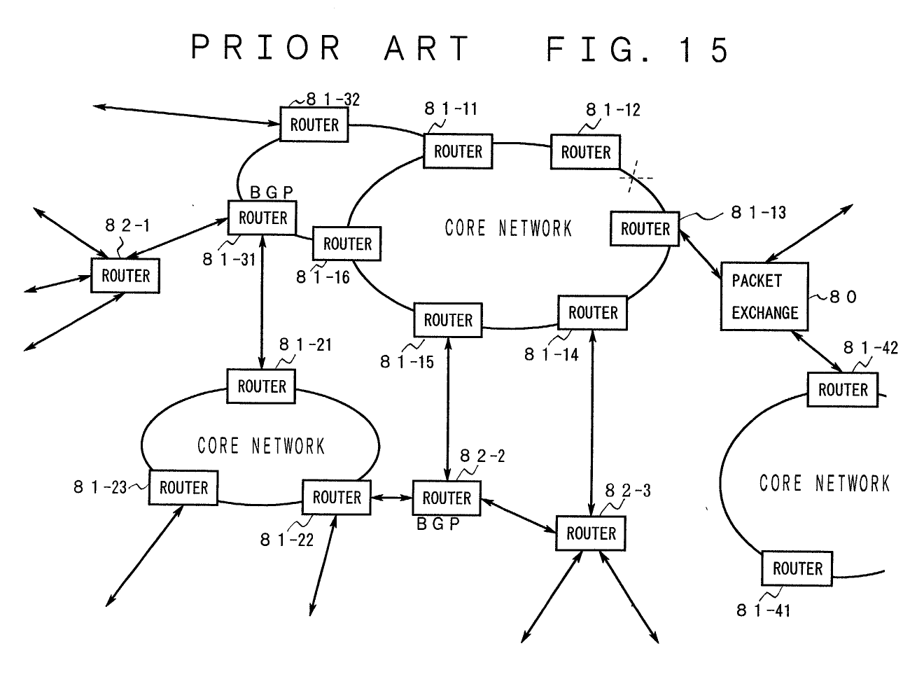

FIG. 16 shows the configuration of a double, time division multiplexing ring network.

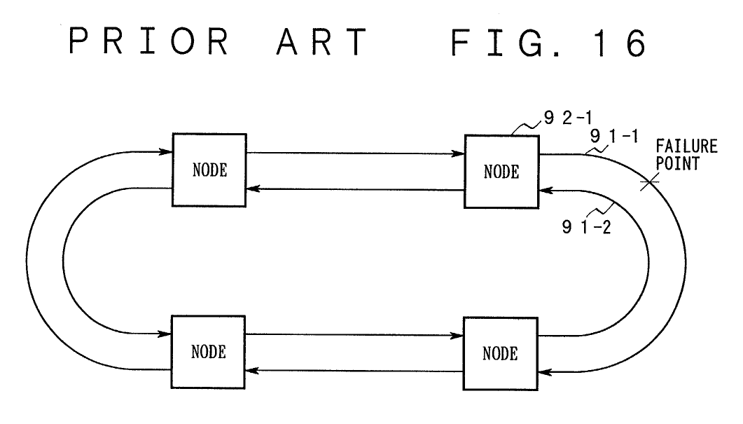

### DESCRIPTION OF THE PREFERRFD EMBODIMENTS

First, the principles of line restoring methods according to the present invention will be described.

In a first line restoring method according to the invention, occurrence of a failure preventing transmission to each of the succeeding transmission sections of a plurality of redundantly configured transmission paths is monitored. While a failure in a specific one of the plurality of transmission paths continues to exist, an attribute of a packet to be relayed from the preceding transmission section of the specific transmission path to its succeeding transmission section as a connectionless service is recognized. When the recognized attribute indicates that the packet is a subject of a best effort service, the packet is relayed by using one of the plurality of transmission paths other than the specific transmission path.

In the above line restoring method, the transmission band of each transmission section is effectively utilized for an general transmission service without being reserved for forming a substitute path for preparing for an unpredictable failure as long as the allowable loss or discard of a packet in a transmission path is recognized as an attribute of the packet as in the case of the best effort service.

Even when a failure has occurred in the succeeding transmission section of a transmission path, the service quality, which might be lowered by relaying a packet via a transmission path substituting the above transmission section, can be highly maintained as long as the circuit configuration, the transmission rate, a traffic distribution of individual transmission sections, and combinations of transmission sections where failures have occurred in parallel are properly determined in advance.

In a second line restoring method according to the invention, active paths and reserve paths capable of substituting the active paths are formed in advance in each of a plurality of redundantly configured transmission paths and occurrence of a failure preventing transmission to each of the succeeding transmission sections of the active paths is monitored. While a failure in a specific one of the active paths continues to exist, an attribute of a packet to be relayed from the preceding transmission section of the specific active path to its succeeding transmission section is recognized. When the recognized attribute indicates that the packet is a subject of a control-loaded service or a guaranteed service, the packet is relayed by using one of the reserve paths substituting the specific active path.

In the above line restoring method, the above-mentioned reserve paths are reliably formed by reserving parts of transmission bands even in a state that no failure has occurred, and are used with promptness and high reliability for relaying a packet in place of an active path having a succeeding transmission section where a failure has occurred.

The parts of the transmission bands of the transmission paths other than the ones assigned to the reserve paths are effectively utilized for a transmission service without substantial deterioration in transmission efficiency and transmission quality as long as the ratio of the transmission bands of the parts to the sum of the transmission bands of the transmission paths is appropriate to a actually possible distribution of traffic.

In a third line restoring method according to the invention, active paths are formed in advance individually in all or part of a plurality of redundantly configured transmission paths and each part of reserve paths capable of substituting part of the active paths are formed in advance in transmission paths other than the transmission paths where the active paths have been formed. Occurrence of a failure preventing transmission to each of the succeeding transmission sections of the plurality of transmission paths is monitored. While a failure that occurred in a specific one of the plurality of transmission paths continues to exist, an attribute of a packet to be relayed from a preceding transmission section of the specific transmission path to its succeeding transmission section is monitored. The packet is relayed by using one of the plurality of transmission paths other than the specific transmission path when the recognized attribute indicates that the packet is a subject of a best effort service, and is relayed by using one of the reserve paths formed in a transmission path other than the specific transmission path when the recognized attribute indicates that the packet is a subject of a control-loaded service or a guaranteed service.

In the above line restoring method, a transmission path or a path capable of substituting a transmission section where a failure has occurred is acquired or secured in a manner to be flexibly adapted to the form of service for transmission of a packet to be relayed, such as the best effort, the control-loaded, and the guaranteed service.

In a fourth line restoring method according to the invention, the plurality of transmission paths are duplexed, circularly formed, and have opposite transmission directions. When a recognized attribute indicates that a packet is a subject of a best effort service, the packet is relayed according to loopback.

In the above line restoring method, the invention can be applied to a transmission system in which packet transmission is performed as a connectionless service via duplex circular transmission paths.

In a fifth line restoring method according to the invention, the plurality of transmission paths are duplexed, circularly formed, have transmission directions. When a recognized attribute indicates that a packet is a subject of a control-loaded service or a guaranteed service, the packet is relayed according to explicit routing.

In the above line restoring method, the invention can be applied to a transmission system in which packet transmission is performed as a connection-oriented communication service via duplex circular transmission paths.

The principles of packet transmission equipments according to the invention will be described below.

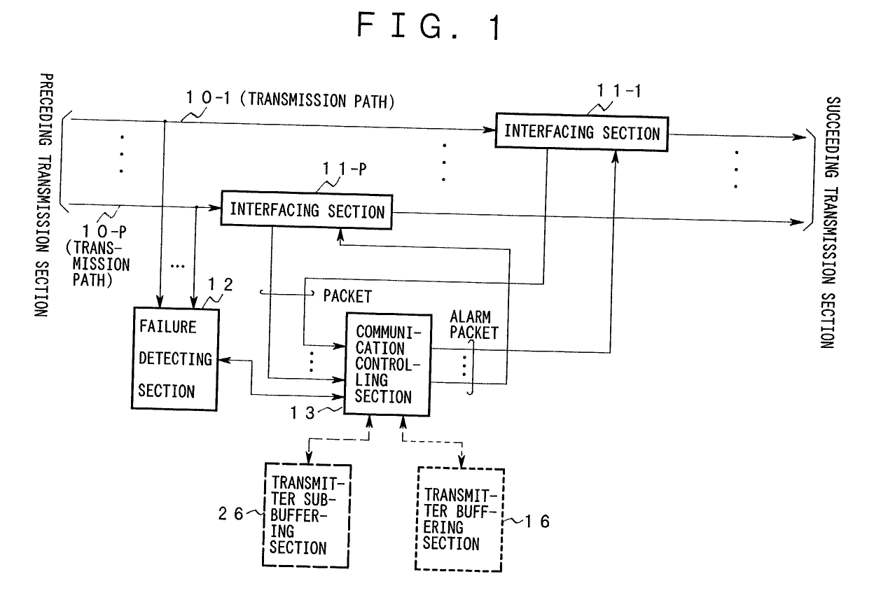

FIG. 1 is a first principle block diagram of a packet transmission equipment according to the invention.

The packet transmission equipment shown in FIG. 1 includes interfacing sections 11-1 to 11-P, a failure detecting section 12, a communication controlling section 13, a transmitter buffering section 16, and a transmitter subbuffering section 26.

The principle of a first packet transmission equipment according to the invention is as follows.

The interfacing sections 11-1 to 1 1-P interface the packet transmission equipment with each of redundantly configured simplex transmission paths 10-1 to 10-P in a physical layer. The failure detecting section 12 detects, in the physical layer, a failure in the preceding transmission sections of each of the transmission paths 10-1 to 10-P. The communication controlling section 13 terminates the transmission paths 10-1 to 10-P via the interfacing sections 11-1 to 11-P in a transport label layer, and transmits an alarm packet indicating a failure detected by the failure detecting section 12 to all or part of the succeeding transmission sections.

In the above packet transmission equipment, a failure that has occurred in any preceding transmission section of the transmission paths 10-1 to 10-P is physically detected and other nodes are notified of the failure via a transport label layer in the form of a message.

Therefore, among the transmission paths 10-1 to 10-P, a transmission path where the failure has occurred can be utilized for transmission to or from the other nodes in a desired layer superior to the physical layer.

The principle of a second packet transmission equipment according to the invention is as follows.

The communication controlling section 13 adds, to an alarm packet, an identifier of a transmission path where a failure has been detected by the failure detecting section 12.

In the above packet transmission equipment, nodes connected with the packet transmission equipment via the succeeding transmission sections of the transmission paths 10-1 to 10-P are notified of a transmission path where a failure has occurred among the transmission paths 10-1 to 10-P.

Therefore, by identifying the transmission path where the failure has occurred, the nodes can effectively utilize normal transmission sections of the transmission paths 10-1 to 10-P in a desired layer superior to the physical layer.

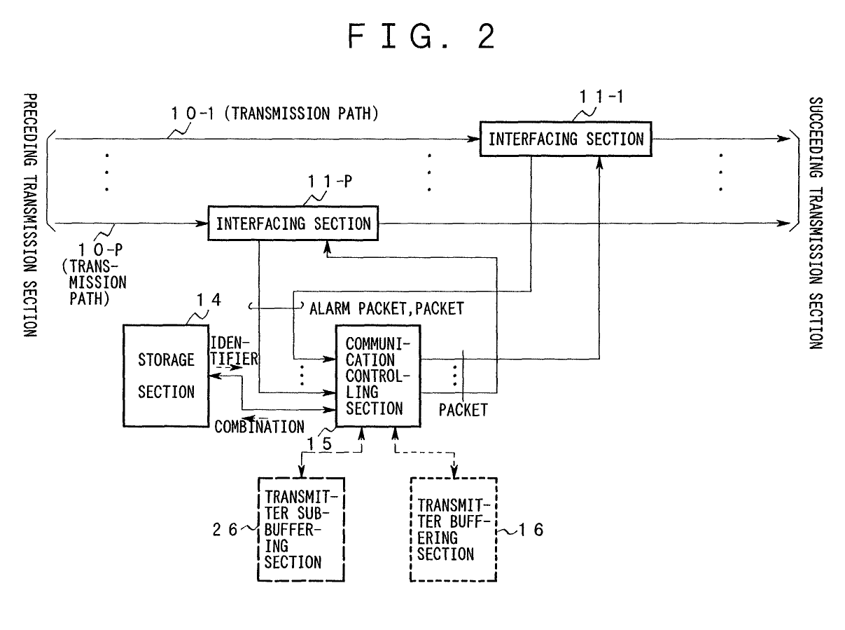

FIG. 2 is a second principle block diagram of a packet transmission equipment according to the invention.

The packet transmission equipment shown in FIG. 2 includes interfacing sections 11-1 to 11-P, a storage section 14, a communication controlling section 15, a transmitter buffering section 16, and a transmitter subbuffering section 26.

The principle of a third packet transmission equipment according to the invention is as follows.

The interfacing sections 11-1 to 11-P interface the packet transmission equipment with each of redundantly configured simplex transmission paths 10-1 to 10-P in a physical layer. Identifiers of transmission paths which respectively conform to a pair of either or both of a sender and a destination of a packet to be transmitted to one of succeeding transmission section of the transmission paths 10-1 to 10-P and a combination of defective transmission sections of the transmission paths 10-1 to 10-P and where the identifiers of the transmission paths in which transmission of the packet is to be actually allowable, are registered in advance in the storage section 14. The communication controlling section 15 terminates the transmission paths 10-1 to 10-P via the interfacing sections 11-1 to 11 -P in a transport label layer and transmits, when receiving an alarm packet including an identifier of a transmission section of one of the transmission paths 10-1 to 10-P and indicating that the transmission section is defective, each packet to be subsequently transmitted to a succeeding transmission section of a transmission path that conforms to a pair of either or both of a sender and a destination of each packet and the received identifier and that is indicated by an identifier registered in the storage section 14.

In the above packet transmission equipment, a transmission section capable of substituting a transmission section where a failure has occurred among the transmission sections of the transmission paths 10-1 to 10-P is promptly determined according to explicit routing in a transport label layer and is used for transmission of a subsequent packet.

Therefore, normal transmission sections of a transmission path where a failure has occurred can be effectively utilized in a manner suitable for a communication service, maintenance, and operation than in a case where other transmission path capable of substituting the transmission path where the failure has occurred is selected among the transmission paths 10-1 to 10-P in a physical layer.

The principle of a fourth packet transmission equipment according to the invention is as follows.

Identifiers of paths to be formed to a destination in a transport label layer are registered in the storage section 14 in ascending order of the number of times crossing-over of different transmission paths performed.

In the above packet transmission equipment, in a path including a transmission section substituting a transmission section where a failure has occurred among paths formed in the transmission paths 10-1 to 10-P, the number of times crossing-over of physically different transmission paths performed is made small.

Therefore, it is possible to increase the transmission efficiency and effectively utilize resources.

The principle of a fifth packet transmission equipment according to the invention is as follows.

Corresponding to the combination of the defective transmission sections, identifiers of transmission paths having succeeding transmission sections not included in a combination of defective transmission sections are registered in advance in the storage section 14.

In the above packet transmission equipment, the communication controlling section can transmit a packet to a succeeding transmission section with guaranteed formation of a normal path to the desired destination of the packet in a transport label layer irrespective of a number and a combination of transmission sections which have not recovered yet from failures which have occurred in parallel among transmission sections of the transmission paths 10-1 to 10-P.

The principle of a sixth packet transmission equipment according to the invention is as follows.

The storage section 14 registers identifiers in a manner that transmission of a packet to normal transmission sections of transmission paths including defective transmission sections among transmission paths 10-1 to 10-P is positively allowable as long as a path is formed to a destination in a transport label layer.

In the above packet transmission equipment, in any path formed in the transmission paths 10-1 to 10-P, succeeding normal transmission sections of a transmission section where a failure has occurred is used together with a path substituting the transmission section in a transport label layer, for packet transmission.

Therefore, it is able to suppress the traffic of a substitute path, reduce the running cost, and increase the service quality.

The principle of a seventh packet transmission equipment according to the invention is as follows.

A transmitter buffering section 16 accumulates packets received from the preceding transmission sections of transmission paths 10-1 to 10-P and to be relayed to the succeeding transmission sections. The communication controlling section 15 discards, among the packets accumulated in the transmitter buffering section 16, packets to be relayed to the succeeding transmission section corresponding to a preceding transmission section where a failure has occurred or that is defective, and adds to an alarm packet a combination of a sender and a number to be used for packet sequencing included in each of the discarded packets.

In the above packet transmission equipment, when a failure has occurred in one of the succeeding transmission sections of the transmission paths 10-1 to 10-P to which a packet stored in the transmitter buffering section 16 is to be transmitted, the packet is discarded and notification is made, in the form of a combination of the sender of the discarded packet and a number, of a packet is to be retransmitted from the sender.

Therefore, the sender of a packet previously transmitted but not yet transferred to the destination can reliably recognize a packet to be retransmitted to a new path determined according to explicit routing or the like in accordance with a failure in a transmission section of the transmission paths 10-1 to 10-P.

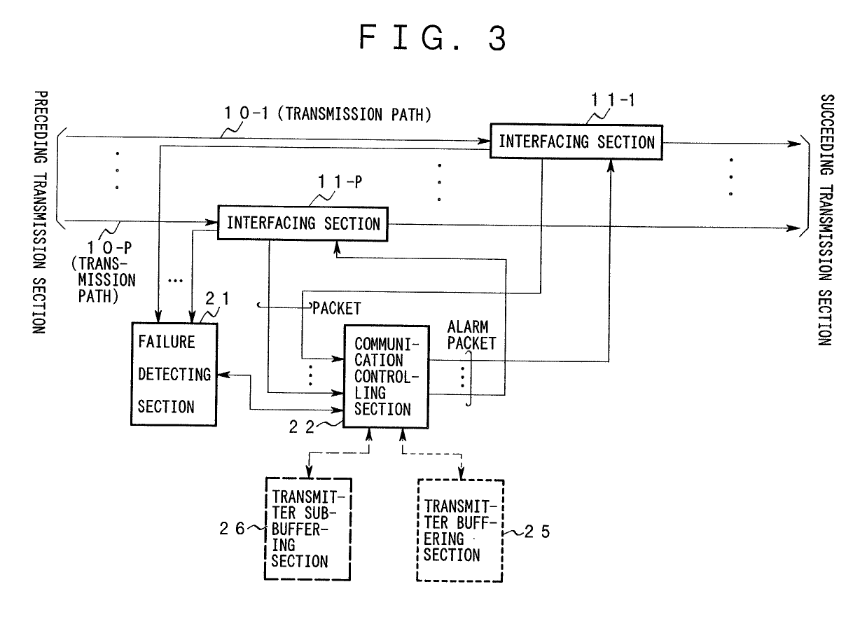

FIG. 3 is a third principle block diagram of a packet transmission equipment according to the invention.

The packet transmission equipment shown in FIG. 3 comprises interfacing sections 11-1 to 1 1-P, a failure detecting section 21, a communication controlling section 22, a transmitter buffering section 25, and a transmitter subbuffering section 26.

The principle of an eighth packet transmission equipment according to the invention is as follows.

The interfacing sections 11-1 to 11-P interface the packet transmission equipment with each of redundantly configured simplex transmission paths 10-1 to 10-P in a physical layer. The failure detecting section 21 detects a failure in the interfacing sections 11-1 to 11-P in the physical layer. The communication controlling section 22 terminates the transmission paths via the interfacing sections 11-1 to 11-P in a transport label layer and transmits to all or part of the succeeding transmission sections an alarm packet indicating a failure detected by the failure detecting section 21 and one, of the interfacing sections 11-1 to 11-P where the failure has been detected.

In the above packet transmission equipment, a failure in any of the interfacing sections 11-1 to 11-P is physically detected and other nodes are notified of the failure as a message via the transport label layer.

This makes it possible to utilize, in a desired layer superior to the physical layer, a transmission section different from either or both of a preceding transmission section and a succeeding transmission section, of the transmission sections of the transmission paths 10-1 to 10-P, that are directly connected with the interfacing sections where the failure has occurred, by the other nodes.

The principle of a ninth packet transmission equipment according to the invention is as follows.

The communication controlling section 22 adds, to the alarm packet, an identifier indicating a form of failure in the interfacing sections detected by the failure detecting section 21.

In the above packet transmission equipment, either or both of the preceding and the succeeding transmission sections directly connected with the interfacing section where the failure has occurred is notified to each node connected via a normal succeeding transmission section other than the above transmission sections among the transmission sections of the transmission paths 10-1 to 10-P.

Therefore, by identifying a transmission section where a failure has occurred, these nodes can effectively utilize normal transmission sections among the transmission sections of the transmission paths 10-1 to 10-P in a desired layer superior to the physical layer.

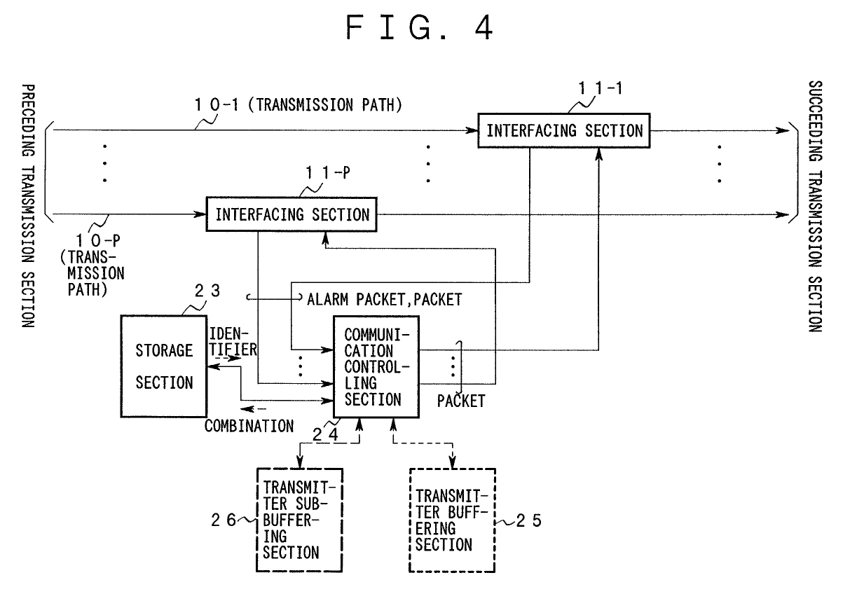

FIG. 4 is a fourth principle block diagram of a packet transmission equipment according to the invention.

The packet transmission equipment shown in FIG. 4 comprises interfacing sections 11-1 to 11-P, a storage section 23, a communication controlling section 24, a transmitter buffering section 25, and a transmitter subbuffering section 26.

The principle of a tenth packet transmission equipment according to the invention is as follows.

The interfacing sections 11-1 to 11-P interface the packet transmission equipment with each of redundantly configured simplex transmission paths 10-1 to 10-P in a physical layer. The storage section 23 registers in advance identifiers of transmission paths each of which conforms to a combination of either or both of a sender and a destination of a packet to be transmitted to a succeeding transmission sections of the transmission paths 10-1 to 10-P, and either or both of an interfacing section of the interfacing sections 11-1 to 11-P where a failure has occurred and a form of the failure and where the identifier is of a transmission path in which transmission of the packet to be actually allowable. The communication controlling section 24 terminates the transmission paths 10-1 to 10-P via the interfacing sections 11-1 to 11-P in a transport label layer, and transmits, when receiving an alarm packet indicating one of the interfacing sections 11-1 to 11-P where a failure has occurred, each packet to be subsequently transmitted to a succeeding transmission section of a transmission path that conforms to a pair of either or both of a sender and a destination of each packet and the interfacing section where the failure has occurred and that is indicated by an identifier registered in the storage section 23.

In the above packet transmission equipment, among the transmission sections of the transmission paths 10-1 to 10-P, a transmission section capable of substituting a transmission section where a failure has occurred is promptly identified in a transport label layer according to explicit routing and is used for transmission of subsequent packets.

This makes it possible to utilize with efficiency normal transmission sections of a transmission path where a failure has occurred in a manner suitable for a communication service, maintenance, and operation than in a case where other transmission paths capable of substituting the transmission path is selected in a physical layer.

The principle of an eleventh packet transmission equipment according to the invention is as follows.

Forms of failures in the interfacing sections 11-1 to 11-P signifies whether or not each of the interfacing sections 11-1 to 11-P is able to receive a predetermined packet from the preceding transmission sections of transmission paths 10-1 to 10-P.

In the above packet transmission equipment, as long as identifiers that conform to the above forms of failures are registered in advance in the storage section 23, the communication controlling section 24 can receive a packet even via a preceding transmission section directly connected with one of the interfacing sections 11-1 to 11-P where a failure has occurred, when the failure has a specific form.

The principle of a twelfth packet transmission equipment according to the invention is as follows.

Forms of failures in the interfacing sections 11-1 to 11-P signifies whether or not each of the interfacing sections 11-1 to 11-P is able to transmit a predetermined packet to the succeeding transmission sections of transmission paths 10-1 to 10-P connected with each of interfacing sections 11-1 to 11-P.

In the above packet transmission equipment, as long as identifiers that conform to the above forms of failures are registered in advance in the storage section 23, the communication controlling section 24 can transmit a packet even to a succeeding transmission section directly connected with one of the interfacing sections 11-1 to 11-P where a failure has occurred, when the failure has a specific form.

The principle of a thirteenth packet transmission equipment according to the invention is as follows.

The storage section 23 registers identifiers of paths to be formed to a destination in a transport label layer in ascending order of the number of times crossing-over of different transmission paths performed.

In the above packet transmission equipment, in a path among paths formed in the transmission paths 10-1 to 10-P, including a transmission section substituting a transmission section where a failure has occurred, the number of times crossing-over of physically different transmission paths performed can be fewer.

This makes it possible to increase the transmission efficiency and effectively utilize resources.

The principle of a fourteenth packet transmission equipment according to the invention is as follows.

Corresponding to a combination of interfacing sections where failures have occurred, the storage section 23 registers in advance identifiers of transmission paths having succeeding transmission sections connected with interfacing sections not included in the combination.

In the above packet transmission equipment, the communication controlling section 23 can transmit a packet to a succeeding transmission section with guaranteed formation of a normal path to a desired destination of the packet in a transport label layer irrespective of a number and a combination of interfacing sections which have not recovered yet from failures which have occurred in parallel.

The principle of a fifteenth packet transmission equipment according to the invention is as follows.

The storage section 23 registers identifiers in a manner that transmission of a packet is positively allowable to normal transmission sections of transmission paths including transmission sections connected with the interfacing section where the failures have occurred as long as a path to a destination is formed in a transport label layer.

In the above packet transmission equipment, among the transmission paths 10-1 to 10-P, even the succeeding transmission section of a transmission path one of whose transmission section is directly connected with an interfacing section where a failure has occurred can effectively be used for packet transmission as long as the succeeding transmission section is normal.

This suppresses the traffic of a substitute path formed in response to a failure in one of the interfacing sections 11-1 to 11-P, reduces the running cost, and improves the service quality.

The principle of a sixteenth packet transmission equipment according to the invention is as follows.

The communication controlling section 24 relays an alarm packet received from one of the preceding sections of transmission paths 10-1 to 10-P, to all or part of their succeeding transmission sections.

In the above packet transmission equipment, an alarm packet is also transferred to nodes other than the sender of the above alarm packet among the nodes connected with the transmission paths 10-1 to 10-P.

In those nodes, it is possible to recover from failures that occurred in the transmission paths 10-1 to 10-P and the interfacing sections 11-1 to 11-P by performing routing of either or both of packets previously transmitted and packets to be subsequently transmitted independently or though cooperation with each other.

The principle of a seventeenth packet transmission equipment according to the invention is as follows.

A transmitter buffering section 25 accumulates packets received from the preceding transmission sections of transmission paths 10-1 to 10-P and to be relayed to the succeeding transmission sections. The communication controlling section 24 discards, among the packets accumulated in the transmitter buffering section 25, packets to be relayed to a succeeding transmission section via an interfacing section where a failure has been detected and adds, to an alarm packet, a combination of a sender and a number to be used for packet sequencing included in each of the discarded packets.

In the above packet transmission equipment, each packet whose transfer to the destination has not completed yet is discarded when a failure has occurred in the transmission paths 10-1 to 10-P or the interfacing sections 11-1 to 11-P connected with the transmission paths 10-1 to 10-P and the sender is notified of the discard.

Therefore, a node as a sender of each packet can reliably retransmit the packet to a desired incoming/outgoing line when the above failure has occurred as long as it can recognize a combination added to an alarm packet.

The principle of an eighteenth packet transmission equipment according to the invention is as follows.

A transmitter subbuffering section 26 accumulates packets transmitted to the succeeding sections of transmission paths 10-1 to 10-P. The communication controlling section 24 when receiving an alarm packet, transmits with priority a packet including a sender and a number same as those included in the alarm packet among the packets accumulated in the transmitter subbuffering section 26.

In the above packet transmission equipment, among packets transmitted to the succeeding transmission sections of the transmission paths 10-1 to 10-P, a packet notified as an alarm packet by other node via the transmission paths 10-1 to 10-P is reliably retransmitted to an incoming/outgoing line determined according to routing.

Therefore, the packet transmission equipment can be applied to a data transmission system that is to provide a guaranteed transmission service.

Embodiments of the invention will be hereinafter described in detail with reference to the drawings.

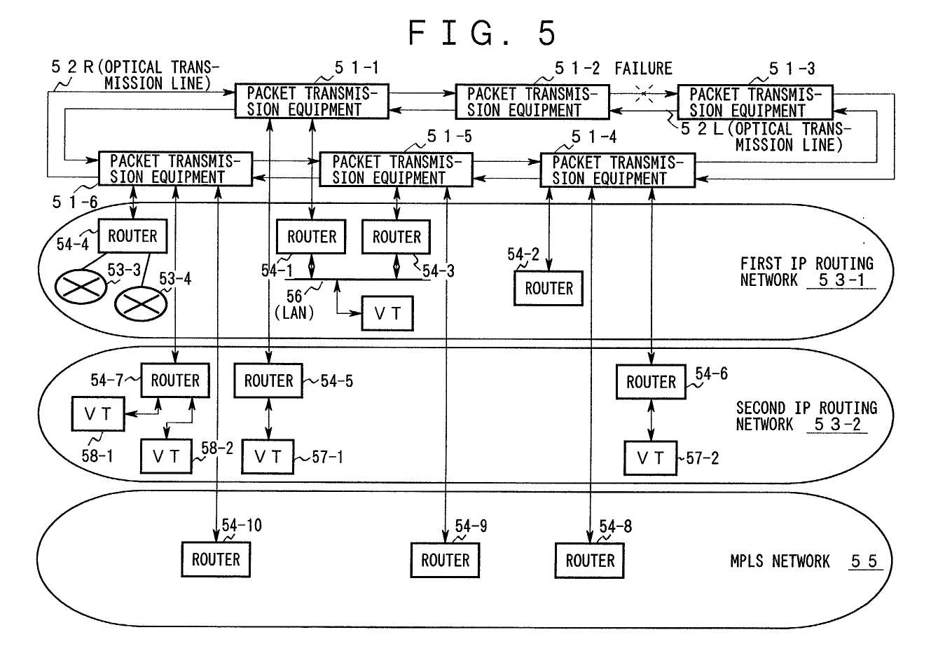

FIG. 5 shows the configuration of the embodiments of the invention.

As shown in FIG. 5, packet transmission equipments 51-1 to 51-6 are provided as nodes on duplex optical transmission lines 52-R and 52-L.

Routers 54-1 to 54-4 are provided as nodes in a first IP routing network 53-1 and routers 54-5 to 54-7 are provided as nodes in a second IP routing network 53-2. Routers 54-8 to 54-10 are provided in an MPLS network 55.

The routers 54-1 and 54-5 are connected with the packet transmission equipment 51-1 and the router 54-1 is also connected with a LAN 56. A video terminal (VT) 57-1 is accommodated by the router 54-5.

The routers 54-2, 54-6, and 54-8 are connected with the packet transmission equipment 51-4 and a video terminal (VT) 57-2 is accommodated by the router 54-6.

The routers 54-3 and 54-9 are connected with the packet transmission equipment 51-5 and the router 54-3 is connected together with the router 54-1, to the LAN 56.

The routers 54-4, 54-7, and 54-10 are connected with the packet transmission equipment 51-6 and third and fourth IP routing networks 53-3 and 53-4 are connected with the router 54-4. Video terminals (VTs) 58-1 and 58-2 are connected with the router 54-7.

Video terminals (VTs) are accommodated by the LAN 56 (see FIG. 5) and the third and fourth routing networks 53-3,53-4. However, since these video terminals (VTs) do not relate to the invention, they are not given a reference symbol or not shown in FIG. 5.

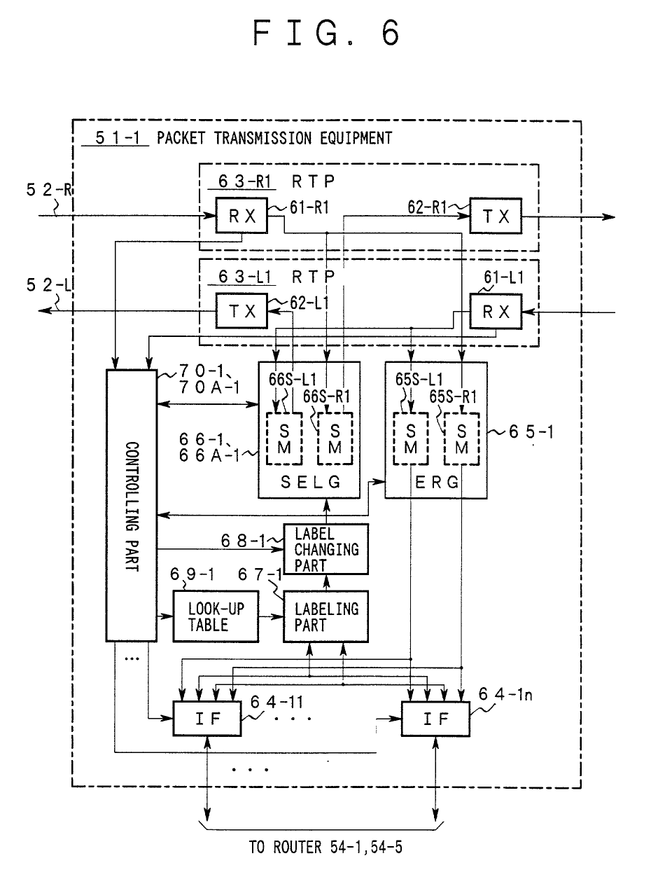

FIG. 6 shows a detailed configuration of the packet transmission equipment 51-1.

The components in FIG. 6 having the corresponding components in FIG. 5 are given the same reference symbols and will not be described.

As shown in FIG. 6, the packet transmission equipment 51-1 is comprised of the following components:

A transmitting/receiving part (RTP) 63-R1 which is composed of a receiving part (RX) 61-R1 disposed at the first stage and a transmitting part (TX) 62-R1 disposed at the final stage and which is connected with a preceding transmission section and a succeeding transmission section of the optical transmission line 52-R.

A transmitting/receiving part (RTP) 63-L1 which is composed of a receiving part (RX) 61-L1 disposed at the first stage and a transmitting part (TX) 62-L1 disposed at the final stage and which is connected with a preceding transmission section and a succeeding transmission section of the optical transmission line 52-L.

Interfacing parts (IFs) 64-11 to 64-1n which interface with the subordinate routers 54-1 and 54-5 etc.

An explicit routing gate (ERG) 65-1 having two input terminals that are connected with outputs of the receiving parts 61-R1 and 61-L1, respectively, and two output terminals connected with first and second control input terminals of the interfacing parts 64-11 to 64-1n.

A G selector (SELG) 66-1 having two output terminals connected with inputs of the transmitting parts 62-R1 and 62-L1, respectively, and two input terminals connected with the outputs of the receiving parts 61-R1 and 61-L1, respectively.

A labeling part 67-1 having two input/output terminals that are connected with first and second input/output terminals, respectively, of each of the interfacing parts 64-11 to 64-1n.

A label changing part 68-1 provided in the interstage between the labeling part 67-1 and the G selector 66-1.

A look-up table 69-1 whose output is connected with a label input of the labeling part 67-1.

A controlling part 70-1 having two alarm input terminals connected with alarm outputs of the receiving parts 61-R1 and 61-L1, respectively, control output terminals directly connected with control input terminals of the label changing part 68-1 and the interfacing parts 64-11 to 64-1n, respectively, a port that is connected with an address terminal of the look-up table 69-1, and ports connected with input/output terminals of the explicit routing gate 65-1 and the G selector 66-1, respectively.

Since the configurations of the packet transmission equipments 51-2 to 51-6 are the same as the configuration of the packet transmission equipment 51-1, the components of the packet transmission equipments 51-2 to 51-6 are given the same reference symbols as the corresponding components of the packet transmission equipment 51-1 except that their last suffixes are “2” to “6,” respectively, and those components will not be described nor illustrated.

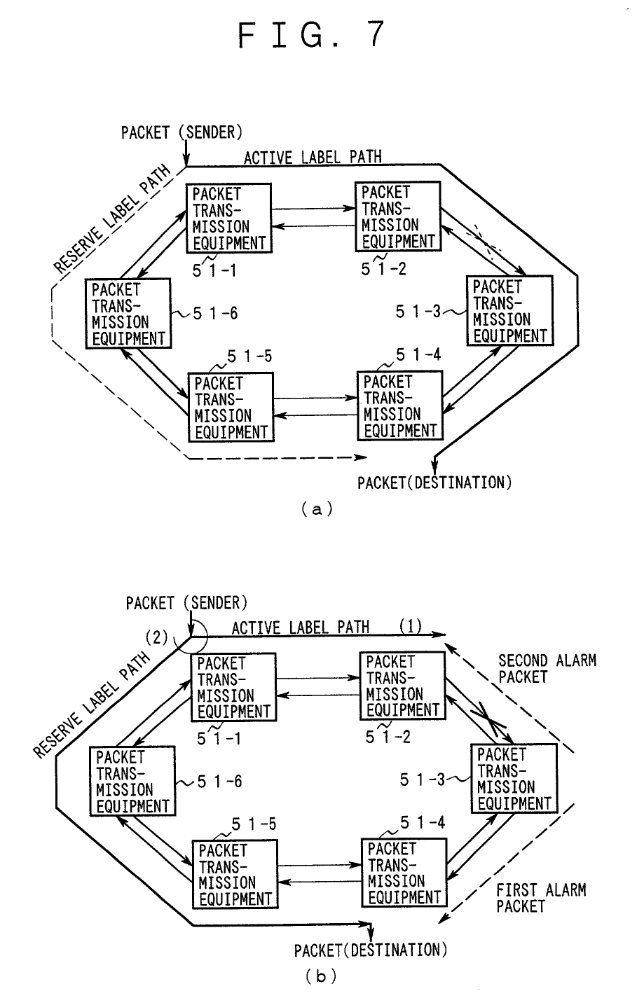

FIGS. 7A and 7B illustrate an operation of a first embodiment of the invention.

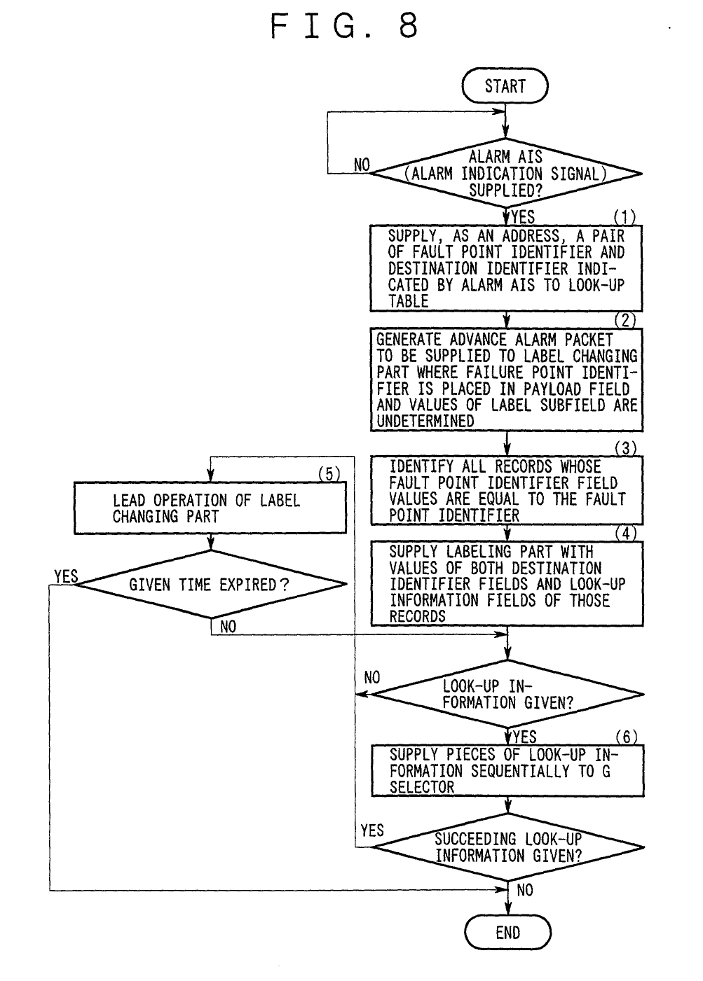

FIG. 8 is a flowchart showing the operation of the controlling part according to the first embodiment of the invention.

The operation of the first embodiment will be described with reference to FIGS. 5 to 7A-7B.

In the following description, for the sake of simplicity, an item common to the packet transmission equipments 51-1 to 51-6 will be described with a character “C” used for individual components instead of the last suffixes “1” to “6.”

In a state that the optical transmission line 52-R is used as an active optical transmission line and the optical transmission line 52-L is used as a reserve optical transmission line, the packet transmission equipment 51-C is supplied, via the preceding transmission section of the optical transmission line 52-R, with a packet to become a subject of one of a control-loaded service, a guaranteed service, and a best effort service in which information indicating the form of service is provided in a predetermined field (described later) and that includes the following elements as shown in FIG. 8.

In the following description, the term “transmission section” section, for a packet to become a subject of a control-loaded service or a guaranteed service, a path that has been established in advance as a connection on the corresponding optical transmission line, and it section, for a packet to become a subject of a best effort service, a predetermined optical transmission line to be used as a connectionless communication line.

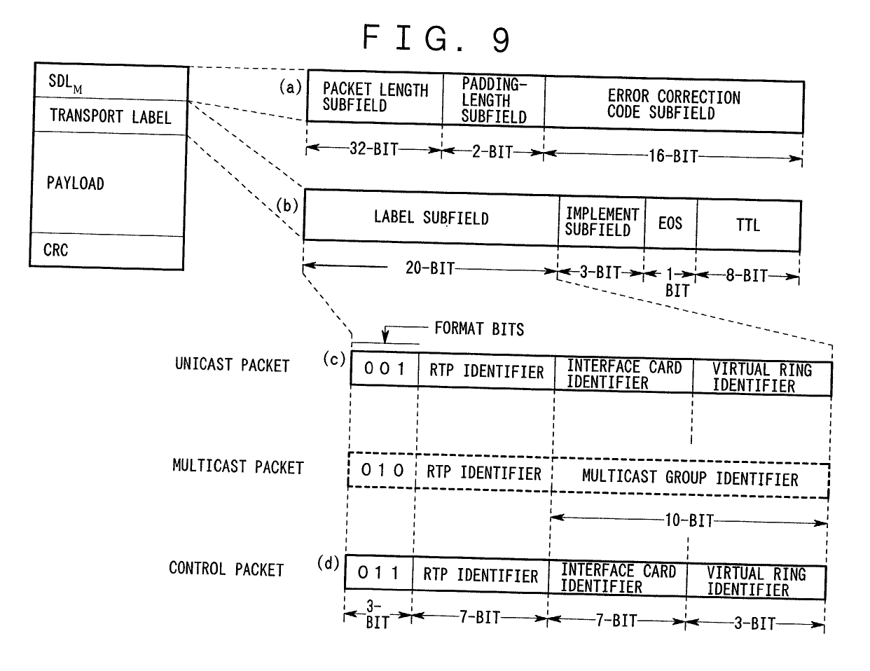

A 32-bit SDLM (simplified data link layer) field which consists of a 14-bit packet length subfield indicating a packet length, a 2-bit padding-length subfield indicating the length of padding bits (described later), and a 16-bit error correction code subfield (see part (a) in FIG. 9)

A 32-bit transport label field which consists of a 20-bit label subfield (described later), a 3-bit implement subfield (this will not be described in detail because of irrelevance to the invention), an EOS (end of label stack indication) subfield to accommodate 1-bit binary information indicating whether the packet concerned is located at the end of a label stack, and an 8-bit TTL subfield indicating the number TTL (time to live per virtual ring) of relays of the packet by routers etc. (see part (b) in FIG. 9).

A payload field which is packed with a single IP packet or an array of a plurality of IP packets formed by dividing transmission information (including alarm information (described later)) and the above-mentioned padding bits and whose length is set at the value of the above-mentioned packet length subfield.

A CRC field which is generated according to a predetermined generator polynomial and which is to be used for detection and correction of bit errors in the entire packet.

The above-mentioned label subfield includes the following elements (see part (c) in FIG. 9) in a case where it is included in a packet (hereinafter referred to as “unicast packet”) to be delivered to a single, specific destination.

Format bits which are a predetermined 3-bit bit string “001” indicating that the packet concerned is a unicast packet.

A 7-bit unique RTP identifier indicating a transmitting/receiving part that is provided in a packet transmission equipment (including the local station) as the destination and that is to be supplied with the unicast packet concerned.

A 7-bit interface card identifier indicating an interfacing part (indicated by symbol 64 in FIG. 6) that is provided in a packet transmission equipment (including the local station) to as the destination and that is to interface, under the transmitting/receiving part indicated by the above-mentioned RTP identifier, with a terminal or the like as the destination.

A 3-bit virtual ring identifier indicating a path or the like to be used for transmission of the packet concerned.

Where the label subfield is included in a packet (hereinafter referred to as “control packet”) to be used for delivery of information other than transmission information as a subject of a transmission service, that is, control information such as an alarm (described later), the label subfield includes the same elements as in the case where it is included in a unicast packet except that the format bits have a value “011” indicating that the packet concerned in a control packet (see part (d) in FIG. 9) and hence it is not described here in detail.

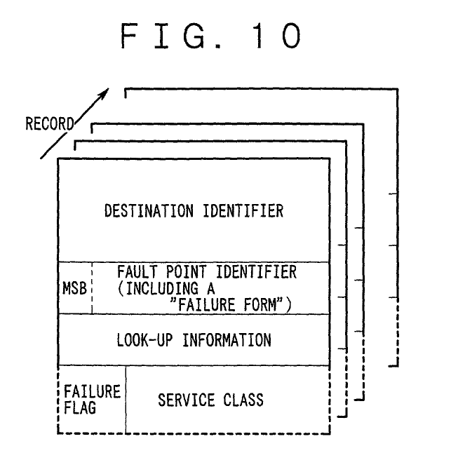

As shown in FIG. 10, an array of records of all combinations that can occur actually as a system configuration among the combinations of the following elements are registered in advance as office data in the look-up table 69-C that is provided in the packet transmission equipment 51-C.

A destination identifier (corresponds to an RTP identifier and an interface card identifier as mentioned above) indicating, among the packet transmission equipments 51-1 to 51-6, a packet transmission equipment for accommodating a terminal or the like that is or is to become the destination of a corresponding unicast packet.

A fault point identifier indicating, among the transmission sections of the optical transmission lines 52-R and 52-L, one of a normal succeeding transmission section to be used for formation of a label path corresponding to the above destination identifier and a succeeding transmission section in which a substitute label path for the above label path should be formed when a failure occurs.

In the following description, for the sake of simplicity, it is assumed that the MSB value of the fault point identifier is set at “1” only in a state that a failure occurs.

Look-up information indicating a succeeding transmission section that should be used in accordance with the destination identifier and the fault point identifier among the succeeding transmission sections of the optical transmission lines 52-L and 52-R.

In the following description, it is assumed that for a packet to become a subject of a control-loaded type service or a guaranteed service the look-up information is given as an identifier of a succeeding transmission section of a label path that has been established in advance as a connection on a corresponding optical transmission line, and that for a packet to become a subject of a best effort service it is given as an identifier of a succeeding transmission section of an optical transmission line to be used as a connectionless communication line.

Further, in the following description, for the sake of simplicity, it is assumed that the form of service to be given to each packet actually (one of a control-loaded type service, a guaranteed service, and a best effort service) is given as office data that are correlated in advance with a combination of the destination identifier and a record number of the look-up table 69-C.

In a period when a failure occurs in one of the transmission sections of the optical transmission lines 52-L and 52-R, the controlling part 70-C determines a failure point identifier indicating the transmission section where the failure exists according to a procedure described later and supplies the determined failure point identifier to the look-up table 69-C as a partial address that should be supplied to the look-up table 69-C as a search key. On the other hand, in a period when no failure exists, the controlling part 70-C supplies the look-up table 69-C with a fault point identifier having a default value indicating that fact also as a partial address.

Operations performed by the individual parts of the packet transmission equipment 51-C in a process that a unicast packet sent from another packet transmission equipment to the packet transmission equipment 51-C is received are as follows.

In the packet transmission equipment 51-C, when the receiving part 61-LC (or 61-RC) receives a certain packet via the preceding transmission section of the optical transmission line 52-L (or 52-R), the received packet is supplied to the explicit routing gate 65-C and the G selector 66-C.

The G selector 66-C judges whether the format bits included in the packet have a value “001.” Only when the judgment result is true, the G selector 66-C recognizes that the packet is a unicast packet and supplies it to the controlling part 70-C.

The explicit routing gate 65-C judges whether the RTP identifier included in the label subfield of the unicast packet indicates the local station. When the judgment result is true, the explicit routing gate 65-C supplies the unicast packet to a subordinate terminal or router via an interfacing part indicated by the interface card identifier included in the label subfield together with the RTP identifier among the interfacing parts 64-C1 to 64-Cn.

Operations performed by the individual parts of the packet transmission equipment 51-C in a process that a unicast packet that is sent from the packet transmission equipment 61-C to another packet transmission equipment are as follows.

A unicast packet that has been supplied to one of the interfacing parts 64-C1 to 64-Cn from a terminal or router as mentioned above is supplied to the labeling part 67-C.

The labeling part 67-C adds, to the label subfield of the unicast packet, a destination identifier (as described later, when a failure has occurred, this can be updated in accordance with a transmission section where the failure has occurred) that is registered in advance in the look-up table 69-C so as to be correlated with an address that is supplied from the controlling part 70-C, and supplies a resulting unicast packet to the label changing part 68-C.

The label changing part 68-c performs, on the unicast packet, processing of updating the contents of the label subfield if necessary according to an instruction from the controlling part 70-c (for simplicity it is assumed here that no updating Is performed), and supplies the updated unicast packet to the G selector 66-C.

The G selector 66-C sends, via the transmitting part 62-LC or 62-RC, the unicast packet to one of the optical transmission lines 52-L and 52-R that is specified under a lead by the controlling part 70-C.

Further, operations performed by the individual parts of the packet transmission equipment 51-C in a process that the packet transmission equipment 51-C relays, to the succeeding transmission section, a unicast packet received from the preceding transmission section of the optical transmission line 52-L or 52-R are as follows.

When the result of the above-mentioned judgment is false, the explicit routing gate 65-C notifies the controlling part 70 about that fact.

When receiving such a notice, the controlling part 70 supplies the above-mentioned unicast packet to the label changing part 68-C.

The label changing part 68-C, the G selector 66-C, and one of the transmitting parts 62-LC and 62-RC perform the above-mentioned processing also on such a unicast packet. Therefore, among unicast packets received from the preceding transmission section of the optical transmission line 52-L or 52-R, unicast packets whose destinations are not the local station are relayed sequentially via the succeeding transmission section (or a label path formed therein) of the optical transmission line 52-L or 52-R.

Incidentally, if a failure (assumed to be disconnection of an optical fiber; indicated by a broken-line mark “x” in FIGS. 5 and 7A) has occurred in, for example, the transmission section from the packet transmission equipment 51-2 to the packet transmission equipment 51-3 among the transmission sections of the current-use optical transmission line 52-R (the main label path indicated by a solid-line arrow in FIG. 7A), the receiving part 61-R3 of the packet transmission equipment 51-3 detects the failure as a state that an optical signal that should be received constantly from the transmission section concerned is not received physically and supplies the controlling part 70-3 with an alarm AIS (alarm indication signal) indicating the above fact and the failure point identifier of the transmission section concerned.

For example, the controlling part 70-3 supplies, as an address, a pair of this fault point identifier and a destination identifier corresponding to the packet transmission equipment 51-3 to the look-up table 69-3 (indicated by symbol (1) in FIG. 8).

The controlling part 70-3 generates an advance alarm packet (for simplicity, it is assumed here that the value of the format bits is set at “011”) in which the failure point identifier included in the alarm AIS indicating the above-mentioned state is provided in the payload field according to a prescribed format and the values of the label subfield are undetermined, and supplies the generated advance alarm packet to the label changing part 68-1 (indicated by symbol (2) in FIG. 8).

The controlling part 70-3 identifies all records whose fault point identifier field value is equal to the above fault point identifier among the records of the look-up table 69-3 (indicated by symbol (3) in FIG. 8). Further, the controlling part 70-3 sequentially supplies the labeling part 67-3 with destination identifiers and pieces of look-up information that are values of the destination identifier fields and the look-up information fields of those records (indicated by symbol (4) in FIG. 8).

The controlling part 70-3 identifies all records whose fault point identifier field value is equal to the above fault point identifier among the records of the look-up table 69-3 (indicated by symbol (3) in FIG. 8). Further, the controlling part 70-3 sequentially supplies the labeling part 67-3 with destination identifiers and pieces of look-up information that are values of the destination identifier fields and the look-up information fields of those records (indicated by symbol (4) in FIG. 8).

The labeling part 67-3 supplies the destination identifiers to the label changing part 68-1.

For the sake of simplicity, it is assumed that the destination identifiers indicate the two respective packet transmission equipments 51-1 and 51-6 that should become destinations.

Under the initiative of the controlling part 70-3 (indicated by symbol (5) in FIG. 8), the label changing part 68-3 generates a first alarm packet and a second alarm packet as RFIs (remote failure indications) by placing in order the destination identifiers as an RTP identifier and an interface card identifier that should be included in the label subfield of the above-mentioned advance alarm packet.

The controlling part 70-3 supplies the pieces of look-up information sequentially to the G selector 66-3 (indicated by symbol (6) in FIG. 8).

As indicated by a broken line in FIG. 7B, the G selector 66-3 sends the first alarm packet of the above alarm packets to the succeeding transmission section of the optical transmission line 52-L via the transmitting part 62-L3 by responding to the look-up information. The G selector 66-3 sends the second alarm packet to the succeeding transmission section of the optical transmission line 52-R via the transmitting part 62-R3.

In the packet transmission equipment 51-2, the receiving part 61 -L2 supplies the G selector 66-2 with the first alarm packet that is supplied from the preceding transmission section of the optical transmission line 52-L. Recognizing that the value of the format bits included in the first alarm packet is “011,” the G selector 66-2 supplies the first alarm packet to the controlling part 70-2.

The controlling part 70-2 judges whether the RTP identifier included in the label subfield of the first alarm packet indicates the local station. When the judgment result is false, the controlling part 70-2 transmits the first alarm packet to the succeeding transmission section of the optical transmission line 52-L via the G selector 66-2 and the transmitting part 62-L2.

Further, the controlling part 70-2 uses, as a partial address that is part of an address that is to be supplied to the look-up table 69-1, the failure point identifier included in the first alarm packet.

Therefore, in the packet transmission equipment 51-2, for each of a unicast packet (in the following description, it is assumed for simplicity that this packet becomes a subject of a control-loaded type service or a guaranteed service) supplied from the preceding transmission section of the optical transmission line 52-R or 52-Lorwhose sender is the self equipment and a control packet, a routing control is performed according to look-up information that is registered in the look-up table 69-2 as corresponding to a destination identifier indicating a destination and a fault point identifier (described above). For example, as indicated by symbol (1) in FIG. 7B, sending or a relay to the succeeding transmission section of the optical transmission line is suspended.

In the packet transmission equipment 51-1, the receiving part 61-L1 accepts the first alarm packet that has been relayed by the packet transmission equipment 51-2 and supplied via the preceding transmission section of the optical transmission line 52-L

Recognizing the value “011” of the format bits included in the first alarm packet, the G selector 66-1 supplies the first alarm packet to the controlling part 70-1.

The controlling part 70-1 judges whether the RTP identifier included in the label subfield of the first alarm packet indicates the local station. Recognizing that the judgement result is true, the controlling part 70-1 uses, as a partial address corresponding to a failure point identifier of an address to be supplied to the look-up table 69-1, the failure point identifier included in the first alarm packet.

Therefore, in the packet transmission equipment 51-1, for each of a unicast packet (for simplicity, in the following description, it is assumed that this packet becomes a subject of a control-loaded type service or a guaranteed service) supplied from the preceding transmission section of the optical transmission line 52-R or 52-L or whose sender is the self equipment and a control packet, a routing control is performed according to look-up information that is registered in the look-up table 69-1 as corresponding to a destination identifier indicating a destination and a failure point identifier (described above) (indicated by symbol (2) in FIG. 7B).

On the other hand, the packet transmission equipment 51-4 is supplied with the above-mentioned second alarm packet via the preceding transmission section of the optical transmission line 52-R. In the packet transmission equipment 51-4, relay processing similar to the relay processing that is performed in the packet transmission equipment 51-2 for the first alarm packet is performed for the second alarm packet.

The packet transmission equipments 51-5 and 51-6 perform relay processing similar to the relay processing that is performed in the packet transmission equipment 51-4.

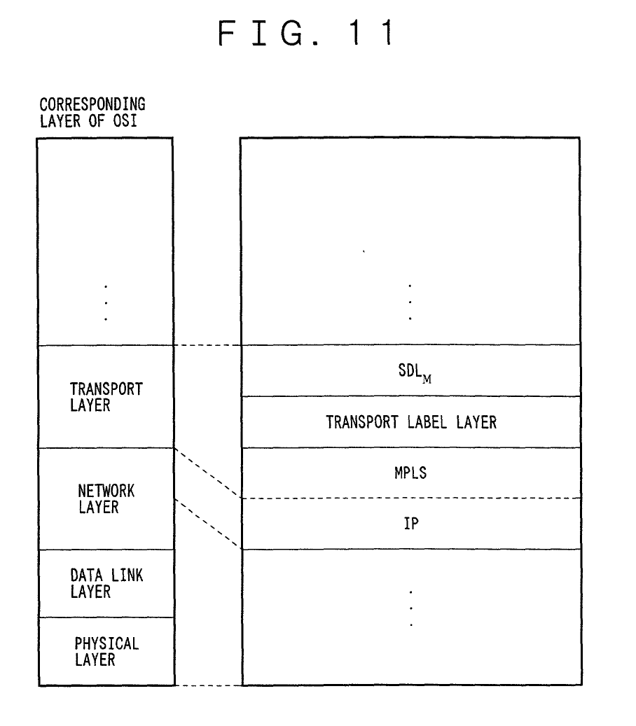

As described above, in this embodiment, when a failure has occurred in the optical transmission line 52-R, a substitute path is formed in a transport label layer that corresponds to a transport layer of the OSI as shown in FIG. 11 by explicit routing that is performed based on a destination identifier, a fault point identifier, and look-up information that are stored in advance in the look-up tables 69-1 to 69-6 as corresponding to a transmission section where the failure has occurred.

Therefore, even if a failure occurs in a transmission section of either of the optical transmission lines 52-R and 52-L, a substitute path is secured more quickly according to the MPLS without passing a large amount of routing information between the packet transmission equipments 51-1 to 51-6 than in the conventional example in which a substitute path is formed in a physical layer (SONET layer).

Further, according to this embodiment, since the value (i.e., the total number of nodes where relays have been performed) of the TTL subfield included in the transport label field is not updated at all during the course of securing a substitute path, packets are prevented from being discarded unduly as this value increases.

In this embodiment, a destination identifier and look-up information that are registered in the look-up table 69-C as corresponding to a failure point identifier is referred to.

However, in the invention, for example, the status of the system may be recognized at a prescribed frequency based on not only such a failure point identifier but also operating statuses of the individual parts of the equipment that have been collected independently by the packet transmission equipment 51-C and control information that has been supplied from the other packet transmission equipments in advance and the look-up table 69-C may be referred to by addressing that is also adapted to a result of the recognition.

In this embodiment, the destination of the second alarm packet is the packet transmission equipment 51-6.

However, the invention is not limited to such a case. For example, the reliability may be increased in such a manner that the destination of the second alarm packet is also set to the packet transmission equipment 51-1 with the combination of pieces of information stored in advance in the look-up table 69-C and the second alarm packet that is received by the packet transmission equipment 51-1 as a duplicate of the first alarm packet is discarded therein.

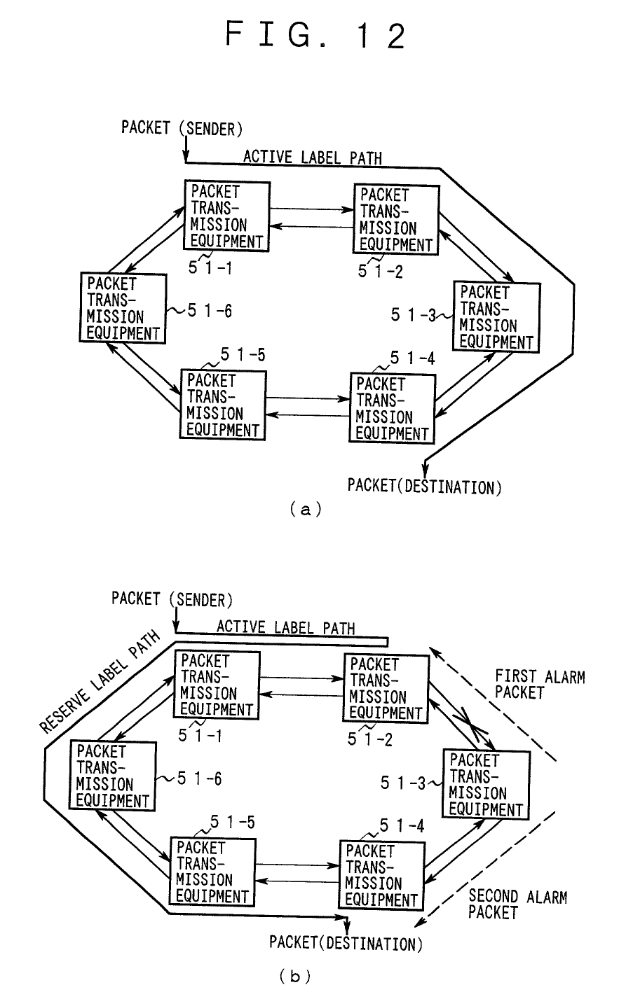

FIGS. 12A and 12B illustrate operations of second to fourth embodiments of the invention.

The operation of the second embodiment of the invention will be described below with reference to FIGS. 5, 6, 9 and 12A-12B.

This embodiment is different from the first embodiment in the contents of the routing table stored in the look-up table 69-C.

The structure of the look-up table 69-C is different from in the first embodiment in the following points:

For a unicast packet (for simplicity, it is assumed that this packet becomes a subject of a best effort service) that is received from the preceding transmission section of the optical transmission line 52-L or 52-R and is to be relayed to the succeeding transmission section of the optical transmission line 52-L or 52-R, look-up information that enables a change of a transmission route from the preceding transmission section of the optical transmission line 52-R to the succeeding transmission section of the optical transmission line 52-L and a change of a transmission route from the preceding transmission section of the optical transmission line 52-L to the succeeding transmission section of the optical transmission line 52-R is stored in advance in the look-up information field (described above).

A service class field is provided in which a service class is stored in advance that indicates, among a best effort service, a guaranteed service, and a control-loaded type service, a service that should be given to a packet (hereinafter referred to as “particular packet”) corresponding to a combination of the values of the destination identifier field, the fault point identifier field, and the look-up information field.

A failure flag field is provided in which a failure flag should be stored that indicates a state that a certain failure has occurred in a succeeding transmission section to be used for a relay of the particular packet and recovery from the failure has not completed yet.

For the sake of simplicity, in the following description, it is assumed that the value of the failure flag field is set at “0” if the corresponding transmission section is normal.

When receiving a failure packet, the controlling part 70-C identifies, among the records of the look-up table 69-C, all particular records in which the same value as the value of the fault point identifier that is accommodated in the payload field of the failure packet is stored in a lower-order portion (except the MSB) of the fault point identifier.

Further, the controlling part 70-C sets the values of the failure flags of those particular records at “1” and maintains those values until recovery of the failure is recognized.

The controlling part 70-C identifies unicast packets to become a subject of a best effort service and to be relayed to a succeeding transmission section in the above-described manner from among unicast packets received from the preceding transmission sections of the optical transmission line 52-L and 52-R by identifying, for each unicast packet, a destination identifier corresponding to the values of the RTP identifier and the interface card identifier that are included in the label subfield of the unicast packet and referring to the service class field of a record whose destination identifier field accommodates the identified destination identifier among the records of the look-up table 69-C.

If a failure has occurred in the succeeding transmission section of the optical transmission line 52-L (or 52-R) that should be used for a relay of the unicast packet concerned ,the controlling part 70-C generates a partial address that consists of a fault point identifier indicating the above transmission section and binary information indicating the above state (corresponding to the value of a failure flag). Further, the controlling section 70-C supplies the partial address to the look-up table 69-C as a search key, and sequentially supplies the contents of the above-identified unicast packet to the label changing part 68-C.

The label changing part 68-C transmits the unicast packet to one of the optical transmission lines 52-R and 52-L to become a substitute transmission path by cooperating with the look-up table 69-C, the G selector 66-C, and the transmitting part 62-RC (or transmitting part 62-LC) in the same manner as in the first embodiment, whereby a relay is performed as a connectionless service.

That is, a unicast packet that is supplied via the preceding transmission section of the optical transmission line 52-L or 52-R, is a subject of a best effort service, and does not have, as a destination, none of the subordinate routers and terminals connected with the local station is transmitted via an optical transmission line that enables loopback in a transport label layer, and it is thereby transmitted to a desired destination without traveling a transmission section where a failure has occurred.

Therefore, for example, for a unicast packet sent from the packet transmission equipment 51-1 to the optical transmission line 52-R and should be transmitted to a router or a terminal accommodated by the packet transmission equipment 51-4 with relays by the packet transmission equipments 51-2 and 51-3 as shown in FIG. 12A, as shown in FIG. 12B the transmission route is changed to the optical transmission line 52-L at the packet transmission equipment 51-2 that is located upstream of a transmission section of the optical transmission line 52-R where a failure has occurred. The unicast packet is transferred to the packet transmission equipment 51-4 with high reliability with relays by not only the packet transmission equipment 51-1 but also the packet transmission equipments 51-6 and 51-5 as the sender.

In the above-described first and second embodiments, only one of a unicast packet to become a subject of a control-loaded service or a guaranteed service and a unicast packet to become a subject of a best effort service is identified and a path or a transmission path to replace a transmission section where a failure has occurred is selected by explicit routing or loopback according to the above-described processing.

However, the invention is not limited to such configurations. For example, when it is possible to reliably select a path or a transmission path by the above-described explicit routing and loopback based on either or both of information provided in one field of a packet supplied from a preceding transmission section and office data supplied in advance, the first and second embodiments may be practiced together.

An operation of a third embodiment of the invention will be described below with reference to FIGS. 5 and 6.

This embodiment is different from the first embodiment in that in the packet transmission equipment 51-C a G selector 66A-C and a controlling part 70A-C are provided in place of the G selector 66-C and the controlling part 70-C, respectively, and that a routing table to be described later is registered in advance in the look-up table 69-C.

In the packet transmission equipment 51-C, for a unicast packet whose sender is the self equipment (controlling part 70-C) or a router or a terminal accommodated by the packet transmission equipment 51-C, a destination identifier, a failure flag, a service class, and lookup information to be used at the time of retransmission is registered in advance in the look-up table 69-C so as to be correlated with a fault point identifier.

Having a buffer memory (not shown) inside, the C selector 66A-C accumulates, in the buffer memory, a predetermined number of packets that have been transmitted to the succeeding sections of the optical transmission lines 52-L and 52-R via the transmitting parts 62-LC and 62-RC.

Every time the controlling part 70A-C accepts a unicast packet that is received from the preceding transmission section of the optical transmission line 52-L or 52-R via the receiving part 61-LC or 61-RC and supplied via the G selector 66A-C, the controlling part 70A-C acquires the latest value of a sequence number that is included in a predetermined field of the unicast packet and is to be used for packet sequencing.

Further, the controlling part 70-C adds the latest value of the sequence number to predetermined fields of a first alarm packet and a second alarm packet to be transmitted to the succeeding transmission sections of the optical transmission lines 52-R and 52-L, respectively, as described above.

Recognizing the first alarm packet or the second alarm packet, the controlling part 70A-C extracts the sequence number that is included in the alarm packet concerned and supplies it to the G selector 66A-C.

The G selector 66A-C supplies the controlling part 70A-C with the contents of a packet including the above sequence number among packets that have been accumulated in the buffer memory in advance and the contents of all packets that were transmitted after the above packet.

The controlling part 70-C supplies the look-up table 69-C with a partial address that has been determined according to the same procedure as in the first embodiment, and supplies the label changing part 68-C with the contents of those packets in the same time-series order as when they were transmitted.

The label changing part 68-C retransmits those packets to one of the optical transmission lines 52-R and 52-L for which a substitute label path has been formed by cooperating with the look-up table 69-C, the G selector 66A-C, and the transmitting part 62RC (or 62-LC) in the same manner as in the first embodiment.

When the retransmission of those packets have completed, the G selector 66A-C supplies a notice to that effect to the controlling part 70-C.

Recognizing this notice, the controlling part 70A-C performs processing that relates to packets to be transmitted or relayed subsequently in the same manner as in the first embodiment.

That is, the packet transmission equipment 51-C reliably retransmits a packet whose sender is the local station to a substitute path that has been formed in the same manner as in the first embodiment even if the transmission of the packet completed after a time point when a failure occurred in a transmission section of the optical transmission lines 52-L or 52-R.

Therefore, this embodiment can be applied to not only a best effort type communication service in which a packet that has been transmitted from the packet transmission equipment 51-C may be discarded during the course of bypassing a substitute path owing to an excessively large TTL value, but also a guaranteed communication service in which such discard of a packet is not permitted.

An operation of a fourth embodiment of the invention according to the invention will be described below with reference to FIGS. 5, 6, 9, and 12A-12B.

This embodiment is different from the first to third embodiments in the contents of the routing tables stored in advance in the look-up tables 69-1 and 69-3 provided in the respective packet transmission equipments 51 and 51-3.

Information indicating that the optical transmission line 52-R should be selected as a succeeding transmission section to which a corresponding unicast packet should be sent is registered in advance in the look-up table 69-1 of the packet transmission equipment 51-1 as long as the destination identifier indicates the packet transmission equipment 51-2 or a subordinate router or terminal connected to the packet transmission equipment 51-2 even if the fault point identifier indicates the transmission section of the optical transmission line 52R from the packet transmission equipment 51-2 to the packet transmission equipment 51-3.

Information indicating that the optical transmission line 52-R should be selected as a succeeding transmission section to which a corresponding unicast packet should be sent is registered in advance in the look-up table 69-3 of the packet transmission equipment 51-3 irrespective of the destination identifier indicating the receiving end of a label path that should become the transmitting end as long as the packet transmission equipment 51-3 corresponds to the label path even if the fault point identifier indicates the transmission section of the optical transmission line 52-R from the packet transmission equipment 51-2 to the packet transmission equipment 51-3.

The procedure of processing that is performed through cooperation of the individual parts of the packet transmission equipments 51-1 and 51-3 while the look-up tables 69-1 and 69-3 are referred to is the same as in the first to third embodiments, and hence will not be described.

As described above, according to this embodiment, the transmission sections of the optical transmission line 52-R other than a transmission section where a failure has occurred can be utilized more effectively for transmission of a desired packet than in the first to third embodiments.

Therefore, packet transmission through any of the sections from the packet transmission equipment 51-4 to the packet transmission equipment 51-2 via the packet transmission equipments 51-5, 51-6, and 51-1 can be performed more efficiently than in a case where transmission is performed via the optical transmission line 52-L having the opposite transmission direction.

Further, the traffic volume of a substitution path formed in a transport label layer in the optical transmission line 52-L in response to the above-mentioned failure is made a much smaller value than in a case where the optical transmission line 52-R is not used for transmission of any packet.

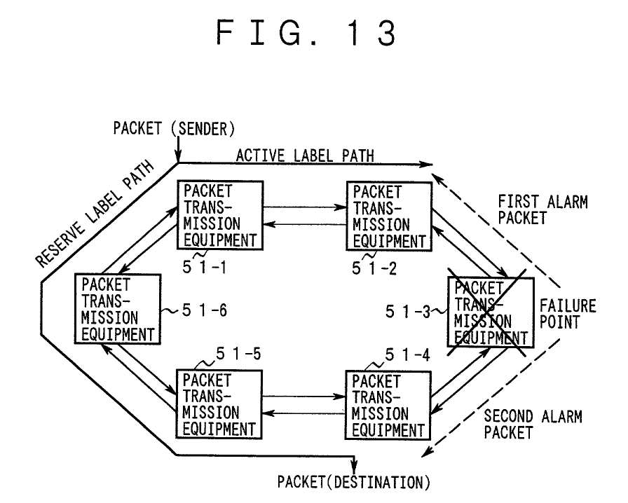

FIG. 13 illustrates an operation of a fifth embodiment of the invention.

The operation of the fifth embodiment will be described below with reference to FIGS. 5, 6, and 13.

This embodiment is different from the first to fourth embodiment in the procedure of processing that is performed by the controlling part 70-C in the packet transmission equipment 51-C.

In the packet transmission equipment 51-C, the explicit routing gate 65-C is provided with submodules (SM) 65S-LC and 65S-RC that correspond to the respective transmitting/receiving parts 63-LC and 63-RC.

The G selector 66-C is provided with submodules (SM) 66S-LC and 66S-RC that correspond to the respective transmitting/receiving parts 63-LC and 63-RC.

The controlling part 70-C monitors, at a predetermined frequency according to a predetermined standard, whether the operating statuses of a first combination consisting of the transmitting/receiving part 63-LC and the submodules 65S-LC and 66S-LC that correspond to the optical transmission line 52-L and a second combination consisting of the transmitting/receiving part 63-RC and the submodules 65S-RC and 66S-RC that correspond to the optical transmission line 52-R are normal.

Based on a result of the above monitoring, the controlling part 70-C performs the same processing as in the first to fourth embodiments as long as the state that both of the first and second combinations operate normally continues.

Further, when judging that the operating status of one of the first and second combinations is abnormal, the controlling part 70-C recognizes that state as one of the following four forms failure or acombination thereof based on a result of the above monitoring:

An L-receiving-system failure in which the operating status of one of the receiving part 61-LC included in the transmitting/receiving part 63-LC and the submodules 65S-LC and 66-LC is defective.

An L-transmitting-system failure in which the operating status of one of the transmitting part 62-LC included in the transmitting/receiving part 63-LC and the submodules 65S-LC and 66-LC is defective.

An R-receiving-system failure in which the operating status of one of the receiving part 61-RC included in the transmitting/receiving part 63-RC and the submodules 65S-RC and 66-RC is defective.

An R-transmitting-system failure in which the operating status of one of the transmitting part 62-RC included in the transmitting/receiving part 63-RC and the submodules 65S-RC and 66-RC is defective.

In this embodiment, the fault point identifier indicates a combination of presence/absence of a transmission section where a failure has occurred among the transmission sections of the optical transmission lines 52-R and 52-L, the transmission section where the failure has occurred, and one of the above four forms of failure that has occurred actually.

In every record that is effective under the system configuration, as appended in parentheses in FIG. 10, a fault point identifier including a “failure form” that indicates a combination of a form concerned among the four forms of failure is registered in advance in the look-up table 69-C.

Incidentally, in the packet transmission equipment 51-3, when recognizing one of the four forms of failure, the controlling part 70-3 supplies, to the look-up table 69-3, as an address, a destination identifier and a fault point identifier that correspond to, for example, the packet transmission equipment 51-2 and an R-receiving-system failure, respectively.

Further, the controlling part 70-3 generates an advance FNM (Fault Notification Message)packet in which the failure point identifier is provided in the payload field in a predetermined format and the value of the label subfield is undetermined, and supplies the generated advance FNM packet to the label changing part 68-3. It is assumed that the frame bits of such an advance FNM packet have a value “011.”

On the other hand, a single or a plurality of (for simplicity, the number is assumed to be two) records corresponding to the above-mentioned address are stored in the look-up table 69-3 in advance. The look-up table 69-3 outputs the values of the destination identifier field and the look-up information field of each record.

Where an L-transmitting-system failure (described above) is included in the failure indicated by the corresponding failure point identifier, the RTP identifier that should be included in the label subfield of the first FNM packet is not defined in the RFP identifier field of each of the above records.

Where an R-transmitting-system failure (described above) is included in the failure indicated by the corresponding failure point identifier, the RTP identifier that should be included in the label subfield of the second FNM packet is not defined in the RFP identifier field of each of the above records.

The labeling part 67-3 supplies the above values to the label changing part 68-3.

Under the initiative of the controlling part 70-3, the label changing part 68-3 generates a first FNM packet as an RFI (remote failure indication) (and a second FNM packet if the number of records is two) by placing the above values as an RTP identifier and an interface card identifier that should be included in the label subfield of the above-mentioned advance FNM packet.

The G selector 66-3 sends the first FNM packet of the above FNM packets to the succeeding transmission section of the optical transmission line 52-L via the transmitting part 62-L3 based on the values of the RTP identifier and the look-up information that are included in the first FNM packet.

The C selector 66-3 transmits the second FNM packet to the succeeding transmission section of the optical transmission line 52-R via the transmitting part 62-R3 based on the value of the RTP identifier included in the second FNM packet.

In the packet transmission equipments 51-1 to 51-6 excluding the packet transmission equipment 51-3 (for simplicity, in the following, each of those packet transmission equipments will be given a reference symbol “51-r” where the suffix “r” represents one of “1,” “2,” “4,” “5,” and “6”), the controlling part 70-r receives either or both of the first FNM packet and the second FNM packet by cooperating with the transmitting/receiving parts 63-Rr and 63-Lr, the explicit routing gate 65-r, the G selector 66-r, the labeling part 67-r, the label changing part 68-r, and the look-up table 69-r in the same manner as in the first embodiment.

Further, the controlling part 70-r extracts the failure point identifier provided in the payload field of each of the FNM packet. If one of the above-mentioned four forms of failure is included in the failure indicated by the extracted failure point identifier, the controlling part 70-r performs the following processing based on the contents of the failure point identifier that is stored in the look-up table 69-r:

(1) A case where an L-receiving-system failure is included in the failure indicated by the failure point identifier: processing of forming a substitute label path that is necessary for recovery of a failure in the transmission section from the packet transmission equipment 51-4 to the packet transmission equipment 51-3 among the transmission sections of the optical transmission line 52-L

(2) A case where an L-transmitting-system failure is included in the failure indicated by the failure point identifier: processing of forming a substitute label path that is necessary for recovery of a failure in the transmission section from the packet transmission equipment 51-3 to the packet transmission equipment 51-2 among the transmission sections of the optical transmission line 52-L.

(3) A case where an R-receiving-system failure is included in the failure indicated by the failure point identifier: processing of forming a substitute label path that is necessary for recovery of a failure in the transmission section from the packet transmission equipment 51-2 to the packet transmission equipment 51-3 among the transmission sections of the optical transmission line 52-R.

(4) A case where an R-transmitting-system failure is included in the failure indicated by the failure point identifier: processing of forming a substitute label path that is necessary for recovery of a failure in the transmission section from the packet transmission equipment 51-3 to the packet transmission equipment 51-4 among the transmission sections of the optical transmission line 52-R.

That is, even when a failure has occurred in one of the transmitting/receiving parts 63-RC and 63-LC, the explicit routing gate 65-C, and the G selector 66-C that interface with the optical transmission lines 52-R and 52-L individually, a substitute label path that is suitable for the form of the failure is formed in a transport label layer as shown in FIG. 13 in the same manner as in the first embodiment.

Therefore, even when a failure has occurred in either of the transmitting/receiving parts 63-RC and 63-LC, a substitute path can be secured more promptly without passing a large amount of routing information among the packet transmission equipments 51-1 to 51-6 than in a case where such a substitute path is formed in a physical layer (SONET layer).

Further, according to this embodiment, since the value (i.e., the total number of nodes where relays have been performed) of the TTL subfield included in the transport label field is not updated at all in securing a substitute path, packets are prevented from being discarded unduly as this value increases.

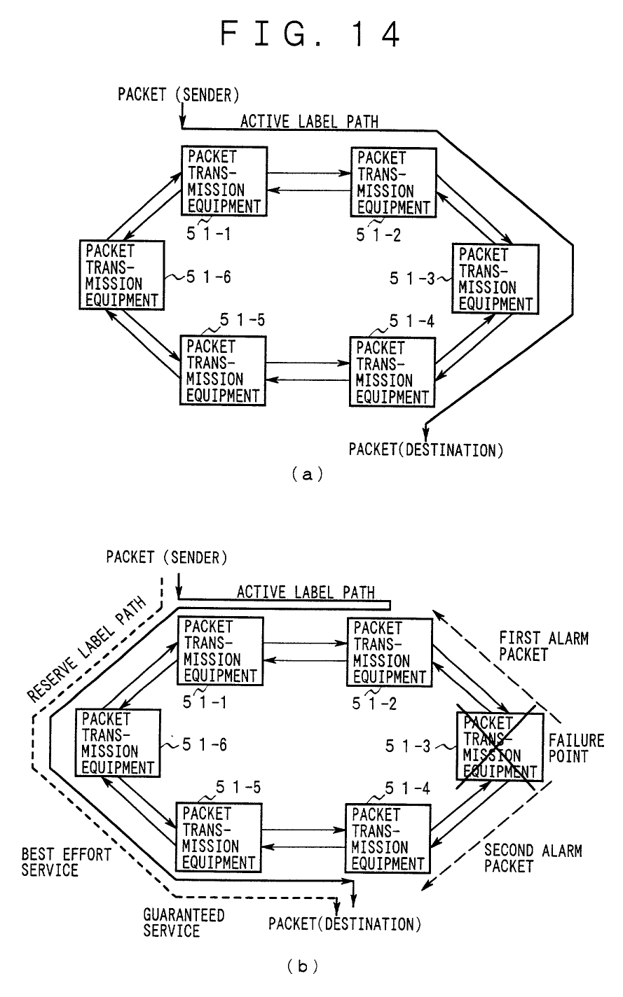

FIGS. 14A and 14B illustrate operations of sixth and seventh embodiments of the invention The operation of the sixth embodiment according to the invention will be described below with reference to FIGS. 5, 6, and 14A-14B.

This embodiment is different from the fifth embodiment in the contents of the routing table that is stored in the look-up table 69-C.

Also for a unicast packet that is received from the preceding transmission section of the optical transmission line 52-L or 52-R and is to be relayed to the succeeding transmission section of the optical transmission line 52-L or 52-R, a destination identifier, a fault point identifier, and look-up information that enable a transmission route change from the preceding transmission section of the optical transmission line 52-R to the succeeding transmission section of the optical transmission line 52-L and those enabling a transmission route change from the preceding transmission section of the optical transmission line 52-L to the succeeding transmission section of the optical transmission line 52-R are stored in the look-up table 69-C in advance.

Based on the values of the RTP identifier and the interface card identifier that are included in the label subfield, the controlling part 70-C identifies unicast packets to be relayed to a succeeding transmission section in the above-described manner among unicast packets received from the preceding transmission sections of the optical transmission line 52-Land 52-R.

The controlling part 70-C supplies the look-up table 69-C with a partial address that has been determined according to the same procedure as in the first embodiment (or the fifth embodiment), and sequentially supplies the contents of the above-identified unicast packets to the label changing part 68-C.

The label changing part 68-C relays the unicast packet by sending it to one of the optical transmission lines 52-R and 52-L in which a substitute label path has been formed by cooperating with the look-up table 69-C and the G selector 66-C and the transmitting part 62-RC (or 62-LC) in the same manner as in the fifth embodiment.

Further, being transmitted via a substitute transmission path that enables loopback in a transport label layer, a unicast packet whose destination is not any of subordinate routers and terminals connected to the self equipment is transmitted to a desired destination with high reliability without traveling a transmission section where a failure has occurred.

Therefore, for example, a unicast packet transmitted from the packet transmission equipment 51-1 to the optical transmission line 52-R and to be transmitted to a subordinate router or terminal relayed by the packet transmission equipments 51-2 and 51-3 and accommodated in the packet transmission equipment 51-4 as shown in FIG. 14A, is transmitted to the packet transmission equipment 51-4 with high reliability in such a manner that the transmission route is changed to the optical transmission line 52-L at the packet 57 transmission equipment 51-2 provided upstream of the transmission section of the optical transmission line 52-R where a failure has occurred and that are relayed by not only the packet transmission equipment 51-1 as the sender but also the packet transmission equipments 51-6 and 51-5 (indicated by a thick solid line in FIG. 14B).

The fifth and sixth embodiments have been described with an assumption that the form of communication service to be provided is the best effort type.

However, these embodiment can similarly be applied to a case where a guaranteed communication service is to be provided under the following conditions:

As in the case of the second embodiment, the packet transmission equipment 51-C is provided with the G selector 66A-C and the controlling part 70A-C in place of the G selector 66-C and the controlling part 70-C, respectively.

For a unicast packet whose sender is the self equipment (controlling part 70-C) or a router or a terminal that is accommodated by the packet transmission equipment 51-C, a succeeding transmission section to be used at the time of retransmission is registered in advance so as to be correlated with a fault point identifier and look-up information.

The individual parts cooperate with each other in the same manner as in the second embodiment.

An operation of the seventh embodiment of the invention will be described below with reference to FIGS. 5, 6, and 14A-14B.

This embodiment is different from the fifth and sixth embodiments in the contents of the routing tables that are stored in advance in the look-up tables 69-1 and 69-3 that are provided in the respective packet transmission equipments 51-1 and 51-3.

Information indicating that the optical transmission line 52-R should be selected as a succeeding transmission path to which a corresponding unicast packet should be sent is registered in each record of the look-up table 69-1 irrespective of the sender identifier as long as the destination identifier indicates the packet transmission equipment 51-2 or a subordinate router or terminal connected to the packet transmission equipment 51-2 even in a case where the fault point identifier indicates that the form of a failure that has occurred in the packet transmission equipment 51-3 is an R-receiving-system failure or the form of a failure that has occurred in the packet transmission equipment 51-2 is an R-transmitting-system failure.

A destination identifier and look-up information indicating that the optical transmission line 52-R should be selected as a succeeding transmission path to be used for transmission of a unicast packet corresponding to the transmitting end should be sent is registered in the look-up table 69-3 as long as the packet transmission equipment 51-3 or a subordinate router or terminal connected to the packet transmission equipment 51-3 relates to the above unicast packet even in a case where the fault point identifier indicates that the form of a failure that has occurred in the packet transmission equipment 51-3 is an R-receiving-system failure or the form of a failure that has occurred in the packet transmission equipment 51-2 is an R-transmitting-system failure.

The procedure of processing that is performed through cooperation of the individual parts of the packet transmission equipments 51-1 and 51-3 is the same as in the fifth and sixth embodiments, and hence will not be described.

As described above, according to this embodiment, even in a state that an Rreceiving-system failure or an R-transmitting-system failure has occurred, the other, normal transmission sections among the transmission sections of the optical transmission line 52-R are utilized more effectively for transmission of a desired packet than in the fifth and sixth embodiments.

Therefore, packet transmission through any of the transmission sections from the packet transmission equipment 51-4 to the packet transmission equipment 51-2 via the packet transmission equipments 51-5, 51-6, and 51-1 is performed more efficiently than in a case where transmission is performed via the optical transmission line 52-L having the opposite transmission direction.

Further, the traffic volume of a substitute label path formed in the optical transmission line 52-L in response to occurrence of the above-mentioned failure is made a much smaller value than in a case where the optical transmission line 52-R is not used parallel for transmission of any packets.

In each of the above embodiments, only the unicast packet is a subject of a transmission service. However, the invention is not limited to such a case. For example, the invention can similarly be applied to transmission of a multicast packet in which the value of the format bits is set at “010” and a 10-bit multicast group identifier is provided in the label subfield in place of the above-mentioned interface card identifier as indicated by a broken line in FIG. 9.

In each of the above embodiments, the individual parts of the packet transmission equipments 51-1 to 51-6 are formed by dedicated hardware units that cooperate with each other in the above-described manner.

However, all or part of the individual parts of the packet transmission equipments 51-1 to 51-6 may be formed by a single or a plurality of processors (DSPs or dedicated hardware units that operate under a microprogram control), or load distribution and function distribution may be done in each of the packet transmission equipments 51-1 to 51-6.

In each of the above embodiment, the packet transmission equipments according to the invention is connected with the duplex, circular optical transmission lines 52-R and 52-L having opposite transmission directions.

However, the invention is not limited to such a case. The invention can be applied to metallic transmission paths and radio transmission paths. The topology of transmission paths may be in any form as long as they are configured redundantly.

Further, the invention is not limited to duplex transmission paths and can similarly be applied to transmission paths that are configured redundantly or load-distributed in any form.

The structure of the look-up table 69-C is not limited to the structure shown in FIG. 10. The look-up table 69-C may be incorporated in or provided with separate information from a look-up table used for realizing ordinary label switching as long as it flexibly adapts to a service class, office data, etc. (described above) and information necessary for forming a substitute path for a label path that is formed according to the MPLS scheme in a transmission section where a failure has occurred is registered therein in advance or updated when necessary.

In each of the above embodiments, most of information to be stored in the look-up table 69-C is given as office data etc. that are constants. However, information to be stored in the look-up table 69-C may be updated manually when necessary (e.g., at the time of occurrence of a failure or recovery from it) by a person who does maintenance or operation. A label path manager may be provided for the above purpose.

In each of the above embodiments, only one reserve label path is shown that replaces a label path formed in a transmission section where a failure has occurred. However, such reserve label paths may be formed in or with a number, transmission capacities, and a combination that are suitable for a combination of transmission sections and locations where failures have occurred, a traffic distribution of the transmission sections at the time of occurrence of the failures, needs relating to maintenance and operation, and other factors, and may be updated when necessary.

The invention is not limited to the above embodiments and various modifications may be made without departing from the sprit and scope of the invention. Any improvement may be made in part of all of the components.

What is claimed is:

1. A line restoring method comprising the steps of:
monitoring each occurrence of a failure preventing transmission to each of succeeding transmission sections of a plurality of redundantly configured transmission paths;
recognizing an attribute of a packet to be relayed as a connectionless service from a preceding transmission section of a specific transmission path, of said plurality of transmission paths, to its succeeding transmission section while a failure in the specific transmission path continues to exist; and
relaying said packet by using one of said plurality of transmission paths other than said specific transmission path when the recognized attribute indicates that said packet is a subject of a best effort service.

2. A line restoring method comprising the steps of:
forming in advance active paths and reserve paths capable of substituting the active paths in each of a plurality of redundantly configured transmission paths;
monitoring each occurrence of a failure preventing transmission to a succeeding transmission section of said active paths,;
recognizing an attribute of a packet to be relayed from a preceding transmission section of a specific active path, of said active paths, to its succeeding transmission section while a failure in the specific active path continues to exist; and
relaying said packet by using one of said reserve paths capable of substituting said specific active path when the recognized attribute indicates that said packet is a subject of either a control-loaded service or a guaranteed service.

3. A line restoring method comprising the steps of:
forming in advance active paths individually in all or part of a plurality of redundantly configured transmission paths and forming reserve paths capable of substituting each part of the active paths in transmission paths other than where the active paths have been formed;
monitoring each occurrence of a failure preventing transmission to each of succeeding transmission sections of said plurality of transmission paths,;
recognizing an attribute of a packet to be relayed from a preceding transmission section of a specific transmission path, of said plurality of transmission paths, to its succeeding transmission section while a failure in the specific transmission path continues to exist; and
relaying said packet by using one of said plurality of transmission paths other than said specific transmission path when the recognized attribute indicates that said packet is a subject of a best effort service, and relaying said packet by using one of said reserve paths formed in advance in a transmission path other than said specific transmission path when the recognized attribute indicates that said packet is a subject of either a control-loaded service or a guaranteed service.

4. A line restoring method according to claim 1, wherein said plurality of transmission paths: is duplexed, circularly formed, and has opposite transmission directions; and
relays said packet according to loopback when said recognized attribute indicates that said packet is a subject of a best effort service.

5. A line restoring method according to claim 2, wherein
said plurality of transmission paths: is duplexed, circularly formed, and has opposite transmission directions; and
relays said packet according to explicit routing when said attribute indicates that said packet is a subject of either a control-loaded service or a guaranteed service.

6. A packet transmission equipment comprising:
a plurality of interfacing section for interfacing the packet transmission equipment with each of redundantly configured simplex transmission paths in a physical layer;
failure detecting section for detecting, in said physical layer, a failure in each of preceding transmission sections of said transmission paths; and
communication controlling section for terminating said transmission paths via said plurality of interfacing section in a transport label layer and transmitting an alarm packet indicating a failure detected by said failure detecting section to all or part of succeeding transmission sections of said transmission paths.

7. A packet transmission equipment according to claim 6,
wherein said communication controlling section adds an identifier of a transmission path where a failure has been detected by said failure detecting section, to said alarm packet.

8. A packet transmission equipment comprising:
interfacing section for interfacing the packet transmission equipment with each of redundantly configured simplex transmission paths in a physical layer;
storage section for registering in advance, an identifier of a transmission path which conforms to a pair of (a) a combination of defective transmission sections of the transmission paths and (b) either or both of a sender and a destination of a packet to be transmitted to one of succeeding transmission sections of said transmission paths,
and where the identifier is of a transmission path in which transmission of the packet is to be actually allowable; and
communication controlling section for terminating said transmission paths via said interfacing section in a transport label layer and transmitting a packet to a succeeding transmission section of a transmission path which conforms to a pair of (a) either or both of a sender and a destination of the packet and (b) the identifier
and which is indicated by an identifier registered in said storage section, when receiving an alarm packet including an identifier of a transmission section of said transmission paths and indicating that the transmission section is defective.

9. A packet transmission equipment according to claim 8,
wherein said storage section registers identifiers of a path to be formed to said destination in said transport label layer, in ascending order of the number of times crossing-over of different transmission paths performed.

10. A packet transmission equipment according to claim 8,
wherein corresponding to said combination of defective transmission sections, said storage section registers in advance identifiers of transmission paths having succeeding transmission sections not included in said combination.

11. A packet transmission equipment according to claim 8,
wherein said storage section registers an identifier in a manner that transmission of said packet is positively allowable to a normal transmission section of a transmission path including a defective transmission section as long as said path is formed in said transport label layer.

12. A packet transmission equipment according to claim 6, further comprising transmitter buffering section for accumulating a packet received from a preceding transmission section of said transmission paths and to be relayed to its succeeding transmission section, and wherein
said communication controlling section discards a packet which is accumulated in said transmitter buffering section and is to be relayed to a succeeding transmission section of a defective transmission section where a failure has been detected or which is defective, and adds a combination of a sender and a number to be used for packet sequencing, included in the discarded packet, to said alarm packet.

13. A packet transmission equipment according to claim 8, further comprising transmitter buffering section for accumulating a packet received from a transmission section preceding said transmission paths and to be relayed to its succeeding transmission section, and wherein
said communication controlling section discards a packet which is accumulated in said transmitter buffering section and is to be relayed to a succeeding transmission section of a defective transmission section where a failure has been detected or which is defective, and adds a combination of a sender and a number to be used for packet sequencing, included in the discarded packet, to said alarm packet.

14. A packet transmission equipment comprising:
a plurality of interfacing section for interfacing the packet transmission equipment with each of redundantly configured simplex transmission paths in a physical layer;
failure detecting section for detecting a failure of said interfacing section in said physical layer; and
communication controlling section for terminating said transmission paths via said plurality of interfacing section in a transport label layer and transmitting an alarm packet indicating a failure detected by said failure detecting section and interfacing section, of said plurality of interfacing section, where the failure has been detected, to all or part of succeeding transmission sections of said transmission paths.

15. A packet transmission equipment according to claim 14,
wherein said communication controlling section adds an identifier, indicating a form of a failure in said interfacing section detected by said failure detecting section, to said alarm packet.

16. A packet transmission equipment comprising:
a plurality of interfacing section for interfacing the packet transmission equipment with each of redundantly configured simplex transmission paths in a physical layer;
storage section for registering in advance an identifier of a transmission path which conforms to a pair of (a) either or both of a sender and a destination of a packet to be transmitted to one of succeeding transmission sections of said transmission paths and (b) a combination of either or both of said interfacing section where a failure has been occurred and a form of the failure,
and where the identifier is of a transmission path in which transmission of the packet is to be actually allowable; and
communication controlling section for terminating said transmission paths via said plurality of interfacing section in a transport label layer and transmitting a packet to a succeeding transmission section of a transmission path which conforms to a pair of (a) either or both of a sender and a destination of the packet and (b) the interfacing section,
and which is indicated by an identifier registered in said storage section, when receiving an alarm packet indicating an interfacing section where a failure has been occurred.

17. A packet transmission equipment according to claim 16,
wherein a form of a failure in said plurality of interfacing section signifies whether or not each of said interfacing section is able to receive a predetermined packet from a preceding transmission section of a transmission path connected with each of said interfacing section.

18. A packet transmission equipment according to claim 16,
wherein a form of failure in said plurality of interfacing section signifies whether or not each of said interfacing section is able to transmit a predetermined packet to a succeeding transmission section of a transmission path connected with each of said interfacing section.

19. A packet transmission equipment according to claim 16,
wherein said storage section registers said identifiers of a path to be formed to said destination in said transport label layer, in ascending order of the number of times crossing-over of different transmission paths performed.

20. A packet transmission equipment according to claim 16,
wherein corresponding to said combination of said interfacing section where a failure has been occurred, said storage section registers in advance identifiers of transmission paths having a succeeding transmission section connected with interfacing section not included in said combination.

21. A packet transmission equipment according to claim 16,
wherein said storage section registers an identifier in a manner that transmission of said packet is positively allowable to a normal transmission section of a transmission path including a transmission section connected with said interfacing section where a failure has been occurred as long as a normal path is formed in said transport label layer.

22. A packet transmission equipment according to claim 6,
wherein said communication controlling section relays an alarm packet received from preceding transmission sections of said transmission paths, to all or part of succeeding transmission sections of said transmission paths.

23. A packet transmission equipment according to claim 8,
wherein said communication controlling section relays an alarm packet received from preceding transmission sections of said transmission paths, to all or part of succeeding transmission sections of said transmission paths.

24. A packet transmission equipment according to claim 14,
wherein said communication controlling section relays an alarm packet received from preceding transmission sections of said transmission paths, to all or part of transmission sections succeeding said transmission paths.

25. A packet transmission equipment according to claim 16,
wherein said communication controlling section relays an alarm packet received from preceding transmission sections of said transmission paths, to all or part of succeeding transmission sections of said transmission paths.

26. A packet transmission equipment according to claim 14, further comprising transmitter buffering section for accumulating a packet received from a preceding transmission section of said transmission paths and to be relayed to its succeeding transmission section, and wherein
said communication controlling section discards a packet which is accumulated in said transmitter buffering section and is to be relayed to a succeeding transmission section via interfacing section where said failure has been detected, and adds a combination of a sender and a number to be used for packet sequencing, included in the discarded packet, to said alarm packet.

27. A packet transmission equipment according to claim 16, further comprising transmitter buffering section for accumulating a packet received from a preceding transmission sections of said transmission paths and to be relayed to its succeeding transmission section, and wherein
said communication controlling section discards a packet which is accumulated in said transmitter buffering section and is to be relayed to a succeeding transmission section via interfacing section where said failure has been detected, and adds a combination of a sender and a number to be used for packet sequencing included in the discarded packet, to said alarm packet.

28. A packet transmission equipment according to claim 6, further comprising transmitter subbuffering section for accumulating a packet transmitted to a succeeding transmission section of said transmission paths, and wherein
said communication controlling section when receiving said alarm packet, transmits with priority a packet accumulated in said transmitter subbuffering section and including a sender and a number same as those included in said alarm packet.

29. A packet transmission equipment according to claim 8, further comprising transmitter subbuffering section for accumulating a packet transmitted to a succeeding transmission section of said transmission paths, and wherein
said communication controlling section when receiving said alarm packet, transmits with priority a packet accumulated in said transmitter subbuffering section and including a sender and a number same as those included in said alarm packet.

30. A packet transmission equipment according to claim 14, further comprising transmitter subbuffering section for accumulating a packet transmitted to a succeeding transmission sections of said transmission paths, and wherein
said communication controlling section when receiving said alarm packet, transmits with priority a packet accumulated in said transmitter subbuffering section and including a sender and a number same as those included in said alarm packet.

31. A packet transmission equipment according to claim 16, further comprising transmitter subbuffering section for accumulating a packet transmitted to a succeeding transmission section of said transmission paths, and wherein
said communication controlling section when receiving said alarm packet, transmits with priority a packet accumulated in said transmitter subbuffering section and including a sender and a number same as those included in said alarm packet.
